(19) United States
(12) Patent Application Publication
(10) Pub. No.: US 2006/0191736 A1
(43) Pub. Date: Aug. 31, 2006

(54) Electric power steering device

(76) Inventors: Atsushi Maeda, Gunma (JP); Kazuo Chikaraishi, Gunma (JP)

Correspondence Address: SUGHRUE MION, PLLC, 2100 PENNSYLVANIA AVENUE, N.W., SUITE 800, WASHINGTON, DC, 20037, US

(21) Appl. No.: 10/550,316

(22) PCT Filed: Apr. 16, 2004
(86) PCT No.: PCT/JP04/05478

§ 371 Date: Sep. 22, 2005

(30) Foreign Application Priority Data
Jun. 25, 2003 (JP) 2003-181517
Jun. 25, 2003 (JP) 2003-181523
Jun. 25, 2003 (JP) 2003-181529
Nov. 21, 2003 (JP) 2003-392623

(51) Int. Cl. B62D 5/04

(52) U.S. Cl. 180/444

(57) ABSTRACT

A subject of the present invention is to provide an electric power steering capable of improving a contact ratio by using an hourglass worm to attain a higher output, and also performing a correction of a misalignment easily by simplifying remarkably a fitting operation of the hourglass worm.

A worm gear system causes a hourglass worm 2 driven by an electric motor 4 to mesh with a worm wheel 3 provided to an output shaft 5, and a bearing 7 on the shaft end side, which bears rotatably the hourglass worm 2 is composed of a tapered roller bearing an outer ring of which can be separated. In a fitting operation, an inner ring 7a and rolling elements 7b are fitted into the hourglass worm 2 and also an outer ring 7c is fitted in advance in a gear housing 1. Then, the tapered roller bearing 7 is assembled in the gear housing 1 by moving the hourglass worm 2 obliquely to a rotating shaft line of the hourglass worm 2 in the gear housing 1 along a raceway of the outer ring 7c.

### TECHNICAL FIELD

The present invention relates to an electric power steering for generating an assist steering torque from an electric motor in response to a steering torque applied to a steering wheel, and then transmitting the assist steering torque to an output shaft of a steering equipment after a speed reduction using a worm gear system.

### BACKGROUND ART

In the field of the vehicle steering system, the so-called power steering for giving the steering assist by using the external power source is widely employed. In the prior art, the hydraulic vane pump is used as the power source of the power steering, and is driven by the engine in most cases. However, it was difficult to employ the power steering of this type in a subcompact car of a small engine capacity, etc. because the hydraulic pump must be driven all the time and thus a heavy driving loss of the engine (almost several horsepower to several tens horsepower at the maximum load) is caused. Further, it was unavoidable that a driving fuel consumption is reduced to an unnegligible extent even in the car of a relatively large engine capacity.

For this reason, as the power steering that is able to overcome above problems, the electric power steering (abbreviated as an “EPS” hereinafter) using an electric motor as the power source is highlighted recently. The EPS has several advantages such that the direct driving loss of the engine can be eliminated because the onboard battery is used as an electric power supply of the electric motor, a reduction of the driving fuel consumption can be suppressed because the electric motor is started only at the time of steering assist, the electronic control can be applied extremely readily, and others.

In this EPS, the assist steering torque is generated from the electric motor in response to the steering torque applied to the steering wheel, and then transmitted to the output shaft of the steering equipment via the power transmission device (reduction gear).

In the EPS employing the worm gear system as this power transmission device (reduction gear), the worm wheel is engaged with the worm on the driving shaft side of the electric motor, and then this worm wheel is fitted onto an output shaft (e.g., a pinion shaft or a column shaft) of the steering equipment.

By the way, the grease development of the worm reduction gear and the resin material development are executed in grappling with the higher output of the EPS. But it is in an awkward situation that the performance of the EPS should be improved tremendously from an aspect of the material. For this reason, the development of the hourglass worm reduction gear that must be able to achieve a breakthrough from an aspect of the mechanism is proceeding in recent years.

The worm reduction gears used up to now are the cylindrical worm reduction gear. The hourglass worm takes an hourglass shape literally in contrast to the cylindrical worm such that a wheel profile is enveloped in the worm. Therefore, it is apparent to everybody that a contact ratio (number) can be improved.

For instance, as the worm gear reduction pair using the cylindrical worm, JP-A-2001-270450 and JP-A-2002-173041 can be listed. In this event, as the EPS using the cylindrical worm, as shown in FIG. 45C of this application, a cylindrical worm b and a worm wheel c that is engaged with the cylindrical worm b are incorporated into a gear housing a of the warm gear system, and also an electric motor d for driving the cylindrical worm b is mounted on the side of the gear housing a. The worm wheel c is fitted onto an output shaft e (e.g., the pinion shaft or the column shaft) of the steering equipment. Accordingly, the assist steering torque is generated from the electric motor d in response to the steering torque applied to the steering wheel (not shown), and then transmitted to the output shaft e of the steering equipment via the cylindrical worm b and the worm wheel c as the reduction gear.

In JP-A-2001-270450, since the number of threads of the worm is set to three, the number of contact teeth is increased and a contact pressure is reduced and thus the abrasion durability can be improved. Also, a tooth bearing state of the three-thread worm is set forth in FIG. 7 of JP-A-2001-270450, and a tooth bearing state (contact surfaces between the worm and the wheel) of the two-thread worm is set forth in FIGS. 8, 9 of JP-A-2001-270450. Also, as shown in FIGS. 45A, 45B (or FIGS. 46A, 46B) of this application, JP-A-2001-270450 discloses respective situations that each contact surface extends in the tooth trace direction and has a slight width in the tooth depth direction, and the contact surface makes contact with the addendum side of the wheel in the initial stage of the engagement and it makes contact with the dedendum side in the final stage of the engagement. In other words, the engagement makes progress while a line of contact in the tooth trace direction is shifting sequentially from the addendum side to the dedendum side.

In JP-A-2002-173041, since the wheel shape that can lengthen a line of contact between the cylindrical worm and the wheel tooth surface is employed, the contact pressure is lowered and thus the abrasion durability can be improved. Also, in JP-A-2002-173041, an improvement is made to increase a tooth bearing area. Since the crowing is provided on both tooth surfaces of the worm and the worm wheel in the tooth trace direction, it can be prevented that the contact length in the tooth trace direction is shortened. That is, in JP-A-2002-173041, the contact portion that is extended in the tooth trace direction can be obtained in contrast to JP-A-2001-270450.

Also, in both JP-A-2001-270450 and JP-A-2002-173041, since a face pressure of the wheel gear made of the resin is lowered by widening the contact area, and thus the abrasion durability can be improved.

In contrast, in JP-A-9-132154 that discloses the hourglass worm, the worm is formed as the hourglass worm that has a worm profile to trace an outer peripheral shape of the wheel. Thus, similarly the number of working teeth can be increased.

In the case of the hourglass worm the development of which is proceeding nowadays, a distance between the rotating shaft of the wheel and the rotating shaft of the worm, both shafts being neither parallel nor intersecting, is increased from the shortest distance, which is given as a length of the common perpendicular line to both rotation shafts (center-to-center distance) in accordance with a rotation phase of the wheel.

Then, an increment a of a pitch circle radius of the worm is given by
σ=R−\sqrt{R²−X²} [Formula 1]
where R is a pitch circle radius of the wheel, and
X is a distance from a common perpendicular line of the worm.

Therefore, the pitch circle diameter of the hourglass worm is symmetrically increased continuously as a position X goes away from the position (X=0), on which the common perpendicular line is located and at which the minimum diameter is given, in the axial direction of the worm.

Meanwhile, as shown in FIG. 47, in the cylindrical worm, the cylindrical worm b is supported rotatably by the gear housing a. In this case, even though the cylindrical worm b is displaced with respect to the gear housing a in the axial direction, such positional displacement has no influence on the engagement between the wheel c and the cylindrical worm b at all, for the pitch circle of the cylindrical worm b has a constant value at any position of the cylindrical worm b in the axial direction, as shown in FIG. 48B in an enlarged fashion.

Here, an enveloping surface obtained by connecting the pitch circle along the axial direction gives a circular cylinder. The illustration shows a sectional shape of the circular cylinder. An intersection point between the cylindrical surface and the pitch circle of the wheel c is not varied even when the cylindrical surface is shifted in the axial direction. In the case of the cylindrical worm b, first the wheel c is incorporated into the gear housing a, and then the cylindrical worm b can be fitted to the wheel c by screwing this worm b into the wheel c from the motor fitting hole g side while rotating it.

However, in the case of the hourglass worm, the position of the minimum pitch circle of the hourglass worm must be aligned very precisely with positions of the common perpendicular line to the rotating shaft of the wheel and the rotating shaft of the worm in the gear housing. When the hourglass worm is displaced to the (−) side with respect to the wheel, both pitch circles go away from each other on one end side of the hourglass worm but both pitch circles intersect with each other on the other end side. Consequently, the backlash becomes large on one end side but the backlash becomes small on the other end side. In the case where a change of the backlash due to the displacement is large, the smooth rotating transmission cannot be executed owing to the interference of tooth surfaces. Also, there exists such a problem that, when the backlash becomes large, the touching sound between mutual tooth surfaces becomes loud. As a result, the position of the hourglass worm in the axial direction must be adjusted precisely.

Also, as shown in FIG. 49A, in the cylindrical worm, a bearing h that bears rotatably the axial end side of the cylindrical worm b is fitted into the gear housing a, and then the wheel c is fitted into the gear housing a. Then, as shown in FIGS. 49B, 49C, the cylindrical worm b is fitted into the bearing h on the axial end side by screwing the worm b into the wheel from the motor fitting hole g side while rotating it, and then a bearing f can be fitted to the motor fitting hole g side. As a result, the assembling operation of the cylindrical worm is extremely easy.

However, in the case of the hourglass worm, the same fitting way as the cylindrical worm cannot be applied because of the interference between the worm and the wheel. Therefore, the hourglass worm must be assembled temporarily while avoiding the interference with the wheel, then the bearings that bear both ends of the hourglass worm are fitted from both ends, and then each position of the end surface of the bearing must be adjusted by a shim, or the like to correct the misalignment. As a result, the assembling operation of the hourglass worm is troublesome.

Also, in the case where first the hourglass worm is fitted into the housing and then the wheel is fitted thereto, the wheel profile must be formed into the shape (e.g., like the helical gear) that does not interfere with the hourglass worm in the axial direction of the wheel. Therefore, the number of working teeth is increased during the engagement between the helical gear wheel and the hourglass worm, nevertheless respective tooth surfaces can mesh merely via a point contact and thus a contact pressure is increased. As a result, such a problem exists that the abrasion durability cannot be improved as expected.

Also, in the cylindrical worm, the pitch circle diameter can be measured simply by the three probe method after the machining process is completed.

However, in the hourglass worm, it is impossible to measure the pitch circle by the conventional three probe method because the pitch circle diameter is changed continuously. Thus, it is difficult to detect precisely the position of the minimum diameter of the pitch circle in the axial direction, and then such position is decided depending on a positional precision deduced from the working reference applied in machining the worm.

As described above, in order to correct the positional displacement (misalignment) caused due to the processing error of the hourglass worm and the housing, the troublesome operation to adjust precisely its position in the axial direction is required of the hourglass worm.

By the way, the conventional EPS worm reduction gear employs the involute tooth profile. When the engagement between the worm having the involute tooth profile and the worm wheel is viewed from the center plane of the worm (the plane that is perpendicular to the wheel shaft to contain the worm shaft), such engagement is equivalent to the engagement between the rack and the pinion (wheel), which appears on the sectional shape of the worm shaft. Normals of both tooth profiles are common at a point of contact of both tooth surfaces of the rack and the pinion (the worm and the wheel), and the normal is tangent to both base circles owing to the definition of the involute. That is, like the case of the gear system with parallel axes, the engagement starts from a point at which the common tangent of both base circles and the tooth surfaces intersect with each other, and then moves from the addendum side to the dedendum side.

The worm reduction gear is different from the gear system with parallel axes resides in that, since the rack teeth proceed by the rotation of the worm, the engagement between the worm and the wheel is performed via the sliding contact on the front surface of the worm.

The sliding contact of the worm and a line of contact in the prior art are directed in the almost same direction. Therefore, the lubricant is exhausted more easily out of the contact range by the rotation of the worm as a line of contact is extended longer in the tooth trace direction.

In contrast, since the worm reduction gear utilizes the sliding transmission, it is a common sense that normally such worm reduction gear is lubricated with oil and thus the lubricant is supplied all the time. However, in the electric power steering, the grease is used as the lubricant for the reasons to improve the handling performance, prevent the contamination due to the oil leakage, prevent the deterioration of the steering feeling due to an increase in the sliding resistance of the sealing member (seal), and so on.

Therefore, according to the conventional approaches set forth in JP-A-2001-270450 and JP-A-2002-173041 to reduce the contact pressure, the desired effect can be achieved in a short term, but the lubricant is carried out of the engaging range when the electric power steering is used over a long term. As a consequence, there existed such a problem that the abrasion is caused abruptly owing to the lubrication failure.

### DISCLOSURE OF THE INVENTION

The present invention has been made in view of the above circumstances, and it is a first object of the present invention to provide an electric power steering capable of improving a contact ratio by using an hourglass worm to attain a higher output, and also performing a correction of a misalignment easily by simplifying remarkably a fitting operation of the hourglass worm.

Also, it is a second object of the present invention to provide an electric power steering capable of improving a lubricating performance by using a tooth profile with a special shape to improve considerably the abrasion durability.

In addition, it is a third object of the present invention to provide an electric power steering capable of improving the contact ratio by using the hourglass worm to attain the higher output, and also attaining the correction of the misalignment easily by simplifying remarkably a positioning operation of the hourglass worm.

In order to achieve the above first object, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, and at least one of bearings that bear rotatably the hourglass worm is composed of a tapered roller bearing, an angular contact bearing, or a magneto ball bearing, from which an outer ring can be separated.

Also, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, a bearing holder that is put onto an outer ring and has a taper surface on an outer peripheral surface is provided to at least one of bearings that bear rotatably the hourglass worm, and a taper hole with which the taper surface of the bearing holder is engaged is formed in a gear housing.

Also, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, a bearing holder that is fitted into an inner ring and has a taper surface on an inner peripheral surface is provided to at least one of bearings that bear rotatably the hourglass worm, and a taper surface that is engaged with the taper surface of the bearing holder is formed on a shaft end portion of the hourglass worm.

Also, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, an inner peripheral surface of an inner ring of at least one of bearings that bear rotatably the hourglass worm is formed as a taper surface, and a taper surface that is engaged with the taper surface of the inner ring is formed on the hourglass worm.

Also, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, and at least one of bearings that bear rotatably the worm wheel is composed of a tapered roller bearing, an angular contact bearing, or a magneto ball bearing, from which an outer ring can be separated.

Also, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, a bearing holder that is put onto an outer ring and has a taper surface on an outer peripheral surface is provided to at least one of bearings that bear rotatably the worm wheel, and a taper hole with which the taper surface of the bearing holder is engaged is formed in a gear housing.

Also, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, and at least one of bearings that bear rotatably the hourglass worm is provided such that a position can be changed with respect to a gear housing in a center-to-center direction.

Also, in order to achieve the above second object, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft, and a tooth profile of the worm wheel and a tooth profile of the worm are shaped into a special tooth profile in which a first line of contact and a second line of contact, which intersect with a sliding direction of the worm and intersect with each other, and a tooth surface of an intermediate gear is formed as a conical surface.

In this case, preferably at least a dedendum shape of the worm should be formed as a hourglass shape.

Also, preferably a consistency of a grease should be set to 385 or less.

Also, preferably a width of the worm wheel should be formed wider than a minimum dedendum circle diameter of the hourglass worm.

Also, preferably a clearance on both end sides should be set larger than a clearance in a center portion of the worm wheel in a tooth trace direction.

Also, preferably the electric motor consists of a brushless motor.

Also, in order to achieve the above third object, in an electric power steering according to the present invention for generating an assist steering torque from an electric motor in response to a steering torque applied to a steering wheel, and then transmitting the assist steering torque to an output shaft of a steering equipment after a speed reduction using a worm gear system, the worm gear system causes a hourglass worm driven by the electric motor to mesh with a worm wheel provided to the output shaft.

Also, preferably a backlash on both end portions of the hourglass worm should be set larger than a backlash in an engagement center portion of the hourglass worm.

Also, preferably a number of working teeth between the hourglass worm and the worm wheel should be increased in response to a transmission torque.

Also, preferably at least one of working teeth of the hourglass worm and the worm wheel can be deformed elastically.

Also, preferably at least tooth portion of the worm wheel should be formed of resin material.

Also, preferably a number of threads of the hourglass worm should be set to 2 threads or more.

Also, preferably a tooth thickness adjusting process of reducing each tooth thickness should be applied to the hourglass worm.

Also, preferably the tooth thickness adjusting process of the tooth thickness adjusting process shapes a tooth profile such that a tooth thickness is thinned toward both end portions from a center portion of the worm in an axial direction.

Also, preferably the tooth thickness adjusting process of the tooth thickness adjusting process shapes the tooth profile such that the process is not applied to a predetermined interval of the center portion of the worm in the axial direction and the process is applied to remaining intervals either to reduce the tooth thickness toward both end portions or to form a constant tooth thickness that is thinner than the tooth thickness in an interval in which the process is not applied.

### BRIEF DESCRIPTION OF THE DRAWINGS

FIG. 1 is a longitudinal sectional view of an electric power steering according to an illustrative example of the present invention.

FIG. 2 is a longitudinal sectional view of an electric power steering according to a first embodiment of the present invention.

FIGS. 3A to 3D are schematic views showing a fitting step of the electric power steering according to the first embodiment respectively.

FIG. 4 is a longitudinal sectional view of an electric power steering according to a second embodiment of the present invention.

FIG. 5 is a longitudinal sectional view of an electric power steering according to a third embodiment of the present invention.

FIG. 6 is a longitudinal sectional view of an electric power steering according to a fourth embodiment of the present invention.

FIG. 7 is a longitudinal sectional view of an electric power steering according to a fifth embodiment of the present invention.

FIG. 8 is a longitudinal sectional view of an electric power steering according to a sixth embodiment of the present invention.

FIG. 9 is a longitudinal sectional view of an electric power steering according to a seventh embodiment of the present invention.

FIG. 10 is a longitudinal sectional view of an electric power steering according to an eighth embodiment of the present invention.

FIG. 11A is a longitudinal sectional view of a column assist electric power steering according to a ninth embodiment of the present invention, and FIG. 11B is a sectional view showing a pertinent portion of a worm gear system of the electric power steering.

FIG. 12A is a longitudinal sectional view of a column assist electric power steering according to a tenth embodiment of the present invention, and FIG. 12B is a sectional view showing a pertinent portion of a worm gear system of the electric power steering.

FIG. 13 is a longitudinal sectional view of an electric power steering according to an eleventh embodiment of the present invention.

FIG. 14 is a longitudinal sectional view of an electric power steering according to a twelfth embodiment of the present invention.

FIG. 15 is a longitudinal sectional view of an electric power steering according to a thirteenth embodiment of the present invention.

FIGS. 16A to 16C are schematic views showing a fitting step of the electric power steering according to the thirteenth embodiment respectively.

FIG. 17 is a longitudinal sectional view of an electric power steering according to a fourteenth embodiment of the present invention.

FIG. 18 is a state diagram of a line of contact in the electric power steering according to the fourteenth embodiment of the present invention.

FIG. 19 is a view showing relationships among a clearance and a worm root diameter and a wheel tooth thickness in the electric power steering according to the fourteenth embodiment of the present invention.

FIG. 20 is a longitudinal sectional view of an electric power steering according to a fifteenth embodiment of the present invention.

FIG. 21A is a longitudinal sectional view of a column assist electric power steering according to the present invention, and FIG. 21B is a sectional view showing a pertinent portion of a worm gear system of the electric power steering.

FIG. 22A is a front view containing a partially sectioned cross section of a pinion assist electric power steering according to the present invention, and FIG. 22B is a sectional view showing a pertinent portion of the electric power steering.

FIG. 23 is a longitudinal sectional view of an electric power steering according to a sixteenth embodiment of the present invention.

FIG. 24A is a longitudinal sectional view of the electric power steering shown in FIG. 23, and FIG. 24B is a schematic view showing a relationship between a pitch circle of an hourglass worm and a pitch circle of a wheel.

FIG. 25A is a longitudinal sectional view of the electric power steering shown in FIG. 23, FIG. 25B is a schematic view showing a relationship between a pitch circle envelope of the hourglass worm and the pitch circle of the wheel, and FIG. 25C is a schematic view showing an extent of a backlash.

FIG. 26A is a longitudinal sectional view showing an hourglass worm reduction gear in an electric power steering according to a seventeenth embodiment of the present invention, and FIG. 26B is an enlarged view of an engaging portion.

FIG. 27 is an enlarged view showing an hourglass worm in FIG. 26A.

FIG. 28A is a longitudinal sectional view showing a reduction gear that contains an assembling error of the hourglass worm, to which a tooth thickness adjusting process is applied, in the axial direction (+ direction), and FIG. 28B is an enlarged view of an engaging portion.

FIG. 29A is a longitudinal sectional view showing a reduction gear that contains the assembling error of the hourglass worm, to which the tooth thickness adjusting process is applied, in the axial direction (− direction), and FIG. 29B is an enlarged view of an engaging portion.

FIG. 30A is a longitudinal sectional view showing an hourglass worm reduction gear in an electric power steering according to an eighteenth embodiment of the present invention, and FIG. 30B is an enlarged view of an engaging portion.

FIG. 31 is an enlarged view showing an hourglass worm in FIG. 30A.

FIG. 32A is a graph showing a relationship between a tooth thickness of a worm and an angle from a center of the worm wheel, and FIG. 32B is a view explaining the graph in FIG. 32A.

FIG. 33A is a longitudinal sectional view showing a reduction gear that contains an assembling error of the hourglass worm, to which the tooth thickness adjusting process is applied, in the axial direction (+ direction), and FIG. 33B is an enlarged view of an engaging portion.

FIG. 34A is a longitudinal sectional view showing a reduction gear that contains the assembling error of the hourglass worm, to which the tooth thickness adjusting process is applied, in the axial direction (− direction), and FIG. 34B is an enlarged view of an engaging portion.

FIG. 35 is an explanatory view showing an engagement between the hourglass worm, to which the tooth thickness adjusting process is applied, and the worm wheel in the small torque transmission.

FIG. 36 is an explanatory view showing the engagement between the hourglass worm, to which the tooth thickness adjusting process is applied, and the worm wheel in the large torque transmission.

FIG. 37A is a longitudinal sectional view showing an hourglass worm reduction gear in an electric power steering according to a nineteenth embodiment of the present invention, and FIG. 37B is an enlarged view of an engaging portion.

FIG. 38 is an enlarged view showing an hourglass worm in FIG. 37A.

FIG. 39A is a graph showing a relationship between a tooth thickness of a worm and an angle wheel from a center of the worm, and FIG. 39B is a view explaining the graph in FIG. 39A.

FIG. 40A is a longitudinal sectional view showing a reduction gear that contains an assembling error of the hourglass worm, to which the tooth thickness adjusting process is applied, in the axial direction (+ direction), and FIG. 40B is an enlarged view of an engaging portion.

FIG. 41A is a longitudinal sectional view showing a reduction gear that contains the assembling error of the hourglass worm, to which the tooth thickness adjusting process is applied, in the axial direction (− direction), and FIG. 34B is an enlarged view of an engaging portion.

FIG. 42A is a longitudinal sectional view showing a hourglass worm reduction gear, to which the tooth thickness adjusting process is not applied, in an electric power steering, and FIG. 42B is an enlarged view of an engaging portion.

FIG. 43A is a longitudinal sectional view showing a reduction gear that contains an assembling error of the hourglass worm, to which the tooth thickness adjusting process is not applied, in the axial direction (+ direction), and FIG. 43B is an enlarged view of an engaging portion.

FIG. 44A is a longitudinal sectional view showing a reduction gear that contains the assembling error of the hourglass worm, to which the tooth thickness adjusting process is not applied, in the axial direction (− direction), and FIG. 44B is an enlarged view of an engaging portion.

FIGS. 45A and 45B are state diagrams showing a line of contact in an electric power steering shown in FIG. 45C in the prior art respectively, and FIG. 45C is a longitudinal sectional view of the electric power steering in the prior art.

FIGS. 46A and 46B are state diagrams showing a line of contact in the electric power steering shown in FIG. 45C in the prior art respectively.

FIG. 47 is a longitudinal sectional view of the electric power steering in the prior art.

FIG. 48A is a longitudinal sectional view of the electric power steering shown in FIG. 47, and FIG. 48B is a schematic view showing a relationship between a pitch circle of a cylindrical worm and a pitch circle of a wheel.

FIGS. 49A to 49C are schematic views showing a fitting step of the electric power steering shown in FIG. 46 respectively.

In Figures, a reference numeral 1 denotes a gear housing, 2 hourglass worm, 3 worm wheel, 4 electric motor, 5 output shaft, 5a torsion bar, 6 bearing, 7 bearing (tapered roller bearing, or the like), 7a inner ring, 7b rolling element, 7c outer ring, 7d taper surface, 8 snap ring, S shim, 10 motor fitting hole, 11 bearing holder, 11a taper surface, 12 taper hole, 13 bearing holder, 13a taper surface, 14 taper surface, 15 preload-adjusting threaded member, 16 fixing nut, 17 preload adjusting plate, 18 bolt, 19 nut, 21 bearing, 22 bearing (tapered roller bearing, or the like), 22a inner ring, 22b rolling element, 22c outer ring, 23 bearing holder, 23a taper surface, 24 taper hole, 31 longitudinal-movement adjusting threaded member, 32 nut, 33 fitting hole on the shaft end side, 41 center-to-center distance adjusting member, 42 elastic body such as spring, rubber, resin, and the like, 43 screw member, 44 O ring, 201 gear housing, 202 hourglass worm, 203 worm wheel, 204 electric motor, 205 output shaft, 205a torsion bar, 206 bearing, 207 bearing (tapered roller bearing, or the like), 208 snap ring, 20S shim, 209 cover, 210 motor fitting hole, 220 worm gear housing, 501 gear housing, 502 hourglass worm, 503 worm wheel, 504 electric motor, 505 output shaft, 505a torsion bar, 506 bearing, 507 bearing, 508 snap ring, 509 cover, 510 motor fitting hole.

### BEST MODE FOR CARRYING OUT THE INVENTION

Electric power steerings according to embodiments of the present invention will be explained with reference to the drawings hereinafter.

### Illustrative Example

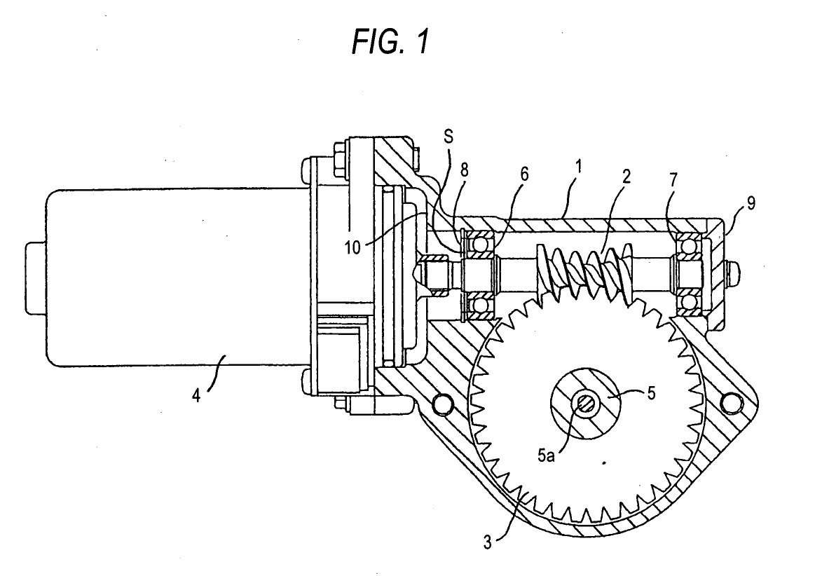

FIG. 1 is a longitudinal sectional view of an electric power steering according to an illustrative example of the present invention.

In this illustrative example, an hourglass worm 2 and a worm wheel 3 that is meshed with the hourglass worm 2 are installed into a gear housing 1 of the worm gear system, and an electric motor 4 for driving the hourglass worm 2 is mounted on the side of the gear housing 1. The worm wheel 3 is fitted onto an output shaft 5 (e.g., a pinion shaft or a column shaft) of the steering equipment. Accordingly, an assist steering torque is generated from the electric motor 4 in response to the steering torque applied to a steering wheel (not shown), and then transmitted to the output shaft 5 of the steering equipment via a reduction gear that consists of the hourglass worm 2 and the wheel 3. Here, a reference numeral 5a denotes a torsion bar.

In this illustrative example, in the case of the hourglass worm 2, the same fitting way as the cylindrical worm cannot be applied because the pitch circles interfere with each other. For this reason, bearings 6, 7 are fitted from both end sides in the situation that the hourglass worm 2 is meshed with the wheel 3. More particularly, the bearings 6, 7 for bearing rotatably both end portions of the hourglass worm 2 are fitted adjustably by a shim S and a cover 9 respectively. Thus, the misalignment can be corrected by adjusting end face positions of the bearings 6, 7 by an end face position of the shim S or the cover 9, etc.

However, in the present illustrative example, it is very troublesome to correct the misalignment of the bearings 6, 7 from both ends of the hourglass worm 2 because there are many adjusting margins and adjusted portions, and thus the fitting operation becomes difficult.

Here, a reference numeral 8 denotes a snap ring. This is common in all embodiments described in the following.

### First Embodiment

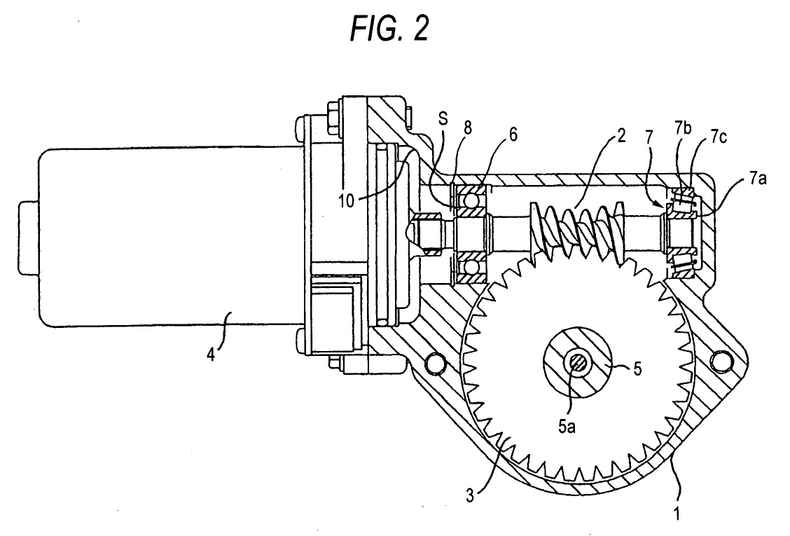

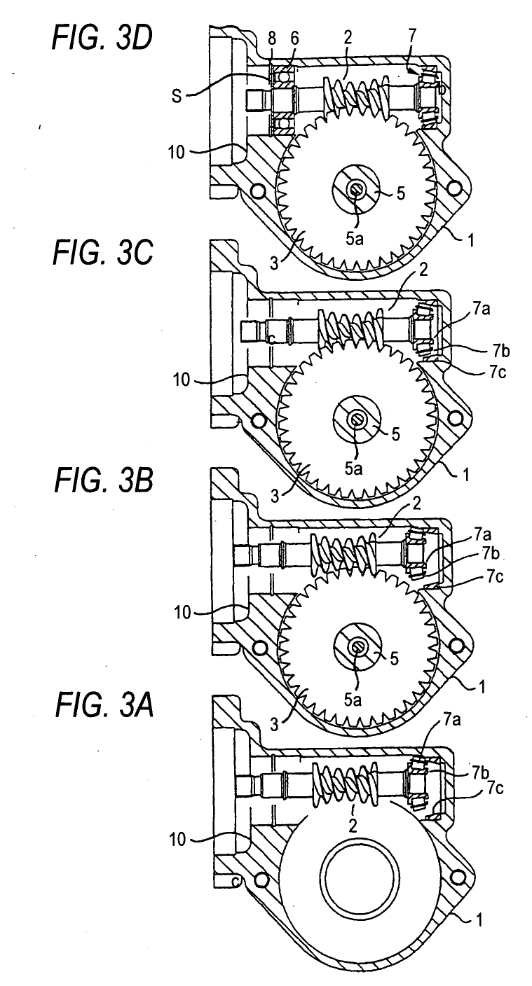

FIG. 2 is a longitudinal sectional view of an electric power steering according to a first embodiment of the present invention. FIGS. 3A to 3D are schematic views showing a fitting step of the electric power steering according to the first embodiment respectively.

In the first embodiment, the hourglass worm 2 and the worm wheel 3 that is engaged with the hourglass worm 2 are installed into the gear housing 1 of the worm gear system, and the electric motor 4 for driving the hourglass worm 2 is mounted on the side of the gear housing 1. The worm wheel 3 is fitted onto the output shaft 5 (e.g., the pinion shaft or the column shaft) of the steering equipment. Accordingly, the assist steering torque is generated from the electric motor 4 in response to the steering torque applied to the steering wheel (not shown), and then transmitted the output shaft 5 of the steering equipment via the reduction gear that consists of the hourglass worm 2 and the wheel 3. Here, the reference numeral 5a denotes a torsion bar.

The bearing 6 for bearing the motor-side end portion of the hourglass worm 2 is composed of the ball bearing, and is fitted such that its position can be adjusted by using the shim S. In contrast, the bearing for bearing the shaft end portion of the hourglass worm 2 is composed of the tapered roller bearing 7 from which an outer ring 7c can be separated and to which both a radial force and a thrust force can be applied.

In the fitting operation, as shown in FIG. 3A, an inner ring 7a and rolling elements 7b are fitted to the hourglass worm 2, while the outer ring 7c is fitted in advance to the gear housing 1.

Then, as shown in FIGS. 3B to 3D, the hourglass worm is moved obliquely to the rotating shaft line of the hourglass worm 2 in the gear housing 1 along the raceway of the outer ring 7c. Thus, the tapered roller bearing 7 is assembled in the gear housing 1.

In this manner, the fitting portion of the tapered roller bearing 7 on the shaft end side is manufactured as a reference portion to eliminate the positional adjustment, and the preload is applied by the bearing 6 on the motor fitting hole 10 side. This preload adjustment is executed by using the shim S.

In other words, the fitting of the hourglass worm 2 into the bearing 7 (tapered roller bearing) on the shaft end side is performed in the oblique direction to the rotating shaft line of the hourglass worm 2. Therefore, the hourglass worm 2 can be fitted from the motor fitting hole 10 side, and also the misalignment can be corrected from one side.

With the above, the contact ratio can be improved by using the hourglass worm 2 to achieve the higher output. Also, the misalignment can be corrected easily by making the fitting operation of the hourglass worm 2 remarkably easy.

### Second Embodiment

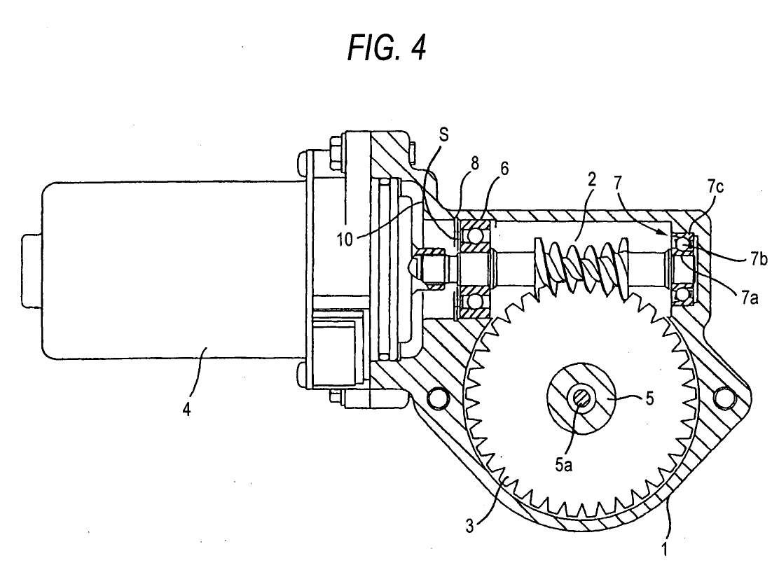

FIG. 4 is a longitudinal sectional view of an electric power steering according to a second embodiment of the present invention.

In the second embodiment, the bearing 6 for bearing the motor-side end portion of the hourglass worm 2 is composed of the ball bearing, and is fitted such that its position can be adjusted by using the shim S. In contrast, the bearing for bearing the shaft end portion of the hourglass worm 2 is composed of the angular contact bearing 7 from which the outer ring 7c can be separated and which can support both the radial force and the thrust force.

In the fitting operation, the inner ring 7a and the rolling elements 7b are fitted to the hourglass worm 2, while the outer ring 7c is fitted beforehand to the gear housing 1. Then, the hourglass worm 2 is moved obliquely to the rotating shaft line of the hourglass worm 2 in the gear housing 1 along the raceway of the outer ring 7c. Thus, the angular contact bearing 7 is assembled in the gear housing 1.

In this manner, the fitting portion of the angular contact bearing 7 on the shaft end side is manufactured as a reference portion to eliminate the positional adjustment, and the preload is applied by the bearing 6 on the motor fitting hole 10 side. This preload adjustment is carried out by using the shim S. In other words, the fitting of the hourglass worm 2 into the bearing 7 (angular contact bearing) on the shaft end side is applied in the oblique direction to the rotating shaft line of the hourglass worm 2. Therefore, the hourglass worm 2 can be fitted from the motor fitting hole 10 side, and also the misalignment can be corrected from one side. With the above, the contact ratio can be improved by using the hourglass worm 2 to achieve the higher output. Also, the misalignment can be corrected easily by facilitating remarkably the fitting operation of the hourglass worm 2.

### Third Embodiment

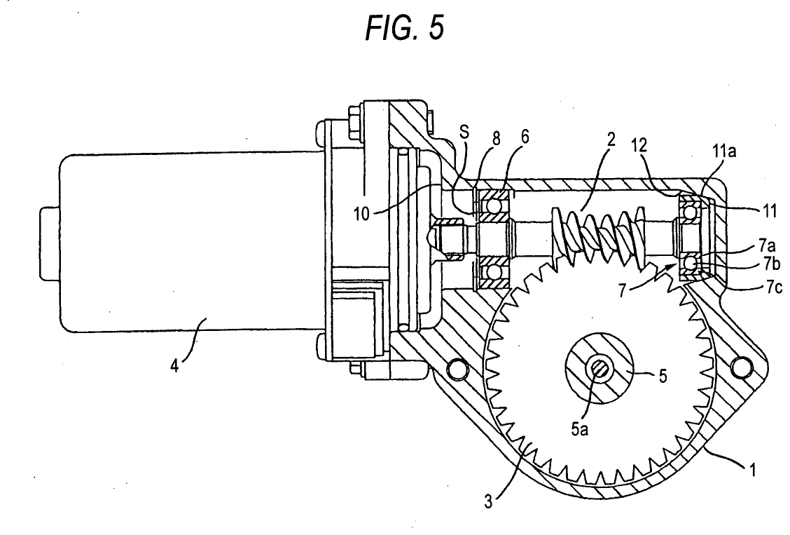

FIG. 5 is a longitudinal sectional view of an electric power steering according to a third embodiment of the present invention.

In the third embodiment, the bearing provided on the shaft end side of the hourglass worm 2 is composed of the deep groove ball bearing 7, and a cylindrical bearing holder 11 having a taper surface 11a on its outer peripheral surface is put on the outer ring 7c of the deep groove ball bearing 7.

A taper hole 12 with which the taper surface 11a of the bearing holder 11 is engaged is formed in the end portion of the gear housing 1.

Therefore, in the fitting operation of the hourglass worm 2, the bearing holder 11 is inserted while sliding the taper surface 11a of the bearing holder 11 along the taper hole 12 of the gear housing 1. In other words, the fitting of the hourglass worm 2 into the bearing 7 (deep groove ball bearing) on the shaft end side is applied in the oblique direction to the rotating shaft line of the hourglass worm 2. Therefore, the hourglass worm 2 can be fitted from the motor fitting hole 10 side, and also the misalignment can be corrected from one side. With the above, not only the contact ratio can be improved by using the hourglass worm 2 to achieve the higher output, but also the misalignment can be corrected readily by simplifying remarkably the fitting operation of the hourglass worm 2.

### Fourth Embodiment

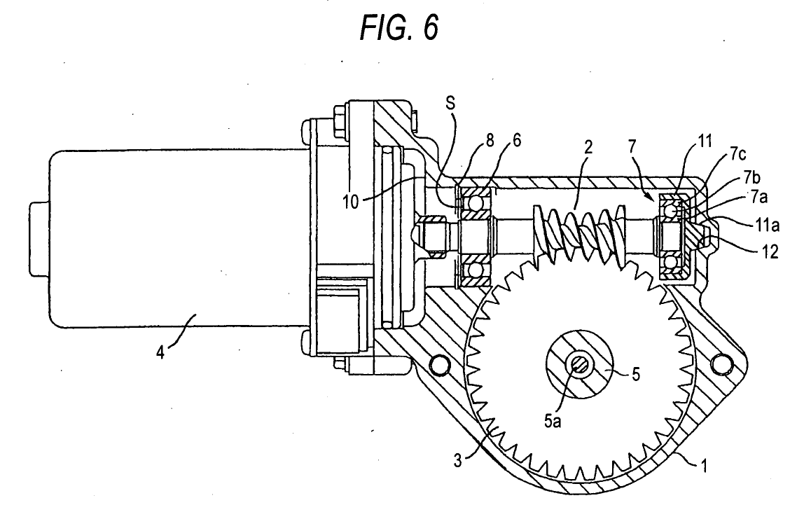

FIG. 6 is a longitudinal sectional view of an electric power steering according to a fourth embodiment of the present invention.

In the fourth embodiment, the bearing provided on the shaft end side of the hourglass worm 2 is composed of the deep groove ball bearing 7, and the cylindrical bearing holder 11 is put on the outer ring 7c of the deep groove ball bearing 7. In this case, the taper surface 11a of the bearing holder 11 is protruded from a substantially central portion of the bearing holder 11 in the axial direction.

The taper hole 12 with which the taper surface 11a of the bearing holder 11 is engaged is formed in the end portion of the gear housing 1.

Therefore, in the fitting operation of the hourglass worm 2, the bearing holder 11 is inserted while sliding the taper surface 11a of the bearing holder 11 along the taper hole 12 of the gear housing 1. In other words, the fitting of the hourglass worm 2 into the bearing 7 (deep groove ball bearing) on the shaft end side is applied in the oblique direction to the rotating shaft line of the hourglass worm 2. Therefore, the hourglass worm 2 can be fitted from the motor fitting hole 10 side, and also the misalignment can be corrected from one side. With the above, the contact ratio can be improved by using the hourglass worm 2 to achieve the higher output. Also, the misalignment can be corrected easily by making the fitting operation of the hourglass worm 2 considerably easy.

### Fifth Embodiment

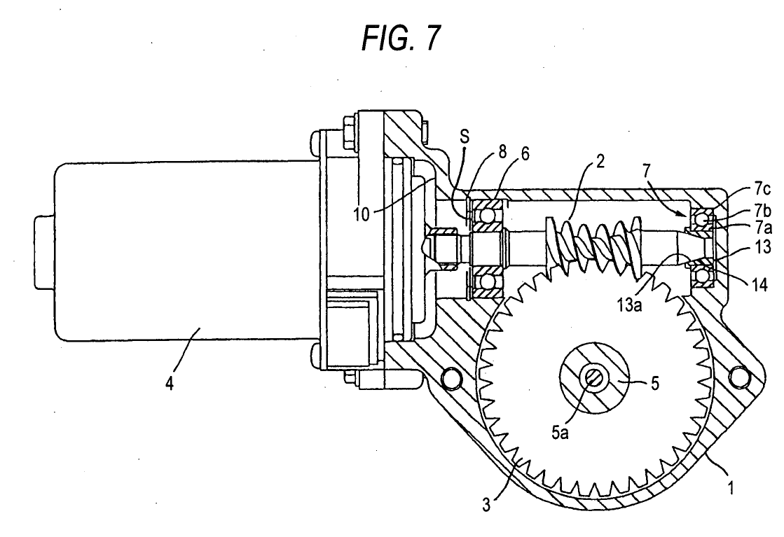

FIG. 7 is a longitudinal sectional view of an electric power steering according to a fifth embodiment of the present invention.

In the fifth embodiment, the bearing provided on the shaft end side of the hourglass worm 2 is composed of the deep groove ball bearing 7, and a cylindrical bearing holder 13 (bush) is fitted into the inner ring 7a of the deep groove ball bearing 7. In this case, a taper surface 13a is formed on an inner peripheral surface of the bearing holder 13 (bush).

A taper surface 14 that is engaged with the taper surface 13a of the bearing holder 13 (bush) is formed on the shaft end portion of the hourglass worm 2.

Therefore, in the fitting operation of the hourglass worm 2, the deep groove ball bearing 7 and the bearing holder 13 (bush) are installed in advance into the gear housing 1, and then the hourglass worm 2 is inserted while sliding the taper surface 14 of the hourglass worm 2 along the taper surface 13a of the bearing holder 13 (bush).

In other words, the fitting of the hourglass worm 2 into the bearing 7 (deep groove ball bearing) on the shaft end side is executed in the oblique direction to the rotating shaft line of the hourglass worm 2. Therefore, the hourglass worm 2 can be fitted from the motor fitting hole 10 side, and also the misalignment can be corrected from one side. With the above, the contact ratio can be improved by using the hourglass worm 2 to get the higher output. Also, the misalignment can be corrected easily by facilitating considerably the fitting operation of the hourglass worm 2.

### Sixth Embodiment

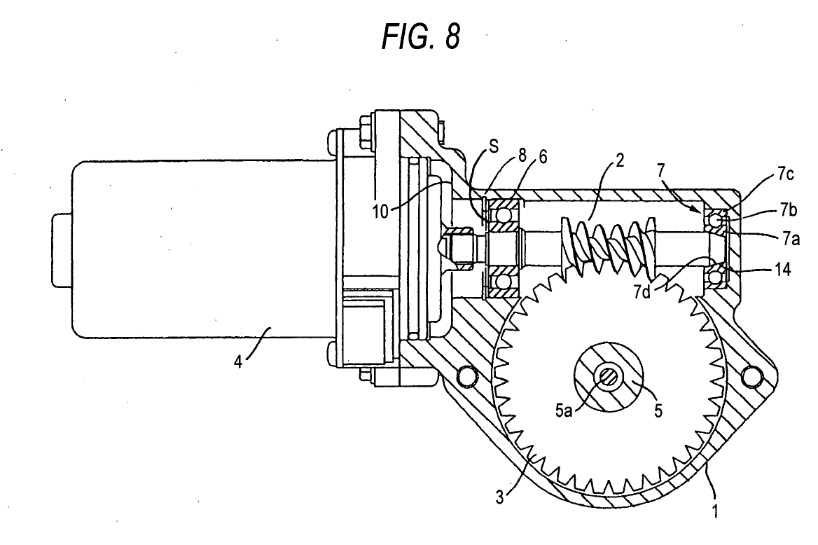

FIG. 8 is a longitudinal sectional view of an electric power steering according to a sixth embodiment of the present invention.

In the sixth embodiment, the bearing provided on the shaft end side of the hourglass worm 2 is composed of the deep groove ball bearing 7, and a taper surface 7d is formed on the inner ring 7a of the deep groove ball bearing 7.

The taper surface 14 that is engaged with the taper surface 7d of the inner ring 7a of the deep groove ball bearing 7 is formed on the shaft end portion of the hourglass worm 2.

Therefore, in the fitting operation of the hourglass worm 2, the deep groove ball bearing 7 is installed previously into the gear housing 1, and then the hourglass worm 2 is inserted while sliding the taper surface 14 of the hourglass worm 2 along the taper surface 7d of the inner ring 7a of the deep groove ball bearing 7.

In other words, the fitting of the hourglass worm 2 into the bearing 7 (deep groove ball bearing) on the shaft end side is applied in the oblique direction to the rotating shaft line of the hourglass worm 2. Therefore, the hourglass worm 2 can be fitted from the motor fitting hole 10 side, and also the misalignment can be corrected from one side. With the above, the contact ratio can be improved by using the hourglass worm 2 to achieve the higher output. Also, the misalignment can be corrected easily by making the fitting operation of the hourglass worm 2 conspicuously easy.

### Seventh Embodiment

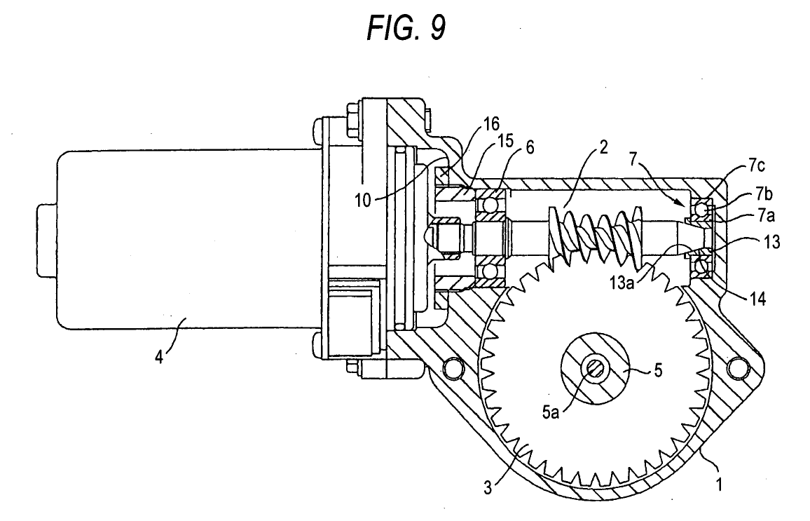

FIG. 9 is a longitudinal sectional view of an electric power steering according to a seventh embodiment of the present invention.

In the seventh embodiment, the bearing provided on the shaft end side of the hourglass worm 2 is composed of the deep groove ball bearing 7, and the cylindrical bearing holder 13 (bush) is fitted into the inner ring 7a of the deep groove ball bearing 7. In this case, the taper surface 13a is formed on the inner peripheral surface of the bearing holder 13 (bush).

The taper surface 14 that is engaged with the taper surface 13a of the bearing holder 13 (bush) is formed on the shaft end portion of the hourglass worm 2.

Therefore, in the fitting operation of the hourglass worm 2, the deep groove ball bearing 7 and the bearing holder 13 (bush) are installed previously into the gear housing 1, and then the hourglass worm 2 is inserted while sliding the taper surface 14 of the hourglass worm 2 along the taper hole 13a of the bearing holder 13 (bush).

In other words, the fitting of the hourglass worm 2 into the bearing 7 (deep groove ball bearing) on the shaft end side is applied in the oblique direction to the rotating shaft line of the hourglass worm 2. Therefore, the hourglass worm 2 can be fitted from the motor fitting hole 10 side, and also the misalignment can be corrected from one side.

Further, in the seventh embodiment, a preload-adjusting threaded member 15 is provided in the motor fitting hole 10 in such a manner that the threaded member is screwed into the gear housing 1 to push the bearing 6. A fixing nut 16 is screwed on the preload-adjusting threaded member 15.

The preload applied to the bearing 6 on the motor side can be adjusted by this preload-adjusting threaded member 15.

With the above, not only the contact ratio can be improved by using the hourglass worm 2 to achieve the higher output, but also the misalignment can be corrected easily by simplifying considerably the fitting operation of the hourglass worm 2.

### Eighth Embodiment

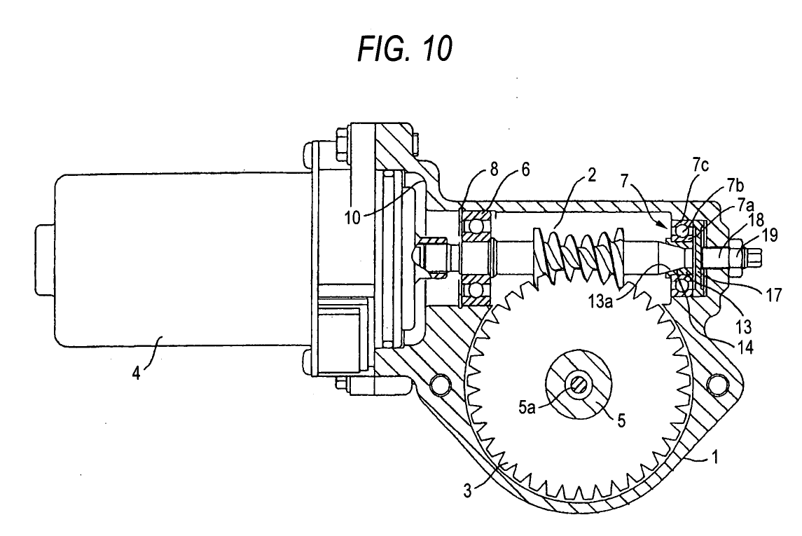

FIG. 10 is a longitudinal sectional view of an electric power steering according to an eighth embodiment of the present invention.

In the eighth embodiment, the bearing provided on the shaft end side of the hourglass worm 2 is composed of the deep groove ball bearing 7, and the cylindrical bearing holder 13 (bush) is fitted into the inner ring 7a of the deep groove ball bearing 7. In this case, the taper surface 13a is formed on the inner peripheral surface of the bearing holder 13 (bush).

The taper surface 14 that is engaged with the taper surface 13a of the bearing holder 13 (bush) is formed on the shaft end portion of the hourglass worm 2.

Therefore, in the fitting operation of the hourglass worm 2, the deep groove ball bearing 7 and the bearing holder 13 (bush) are installed previously into the gear housing 1, and then the hourglass worm 2 is inserted while sliding the taper surface 14 of the hourglass worm 2 along the taper hole 13a of the bearing holder 13 (bush).

In other words, the fitting of the hourglass worm 2 into the bearing 7 (deep groove ball bearing) on the shaft end side is applied in the oblique direction to the rotating shaft line of the hourglass worm 2. Therefore, the hourglass worm 2 can be fitted from the motor fitting hole 10 side, and also the misalignment can be corrected from one side.

Further, in the eighth embodiment, a preload adjusting mechanism is provided in the deep groove ball bearing 7 on the shat end side. As shown in FIG. 10, for example, this preload adjusting mechanism consists of a preload adjusting plate 17 for adjusting the preload of the deep groove ball bearing 7, a bolt 18 for pushing the preload adjusting plate 17, and a nut 19 screwed on the bolt 18.

The preload applied to the deep groove ball bearing 7 on the shaft end side can be adjusted by this preload adjusting mechanism.

With the above, the contact ratio can be improved by using the hourglass worm 2 to achieve the higher output. Also, the misalignment can be corrected easily by making the fitting operation of the hourglass worm 2 considerably easy.

### Ninth Embodiment

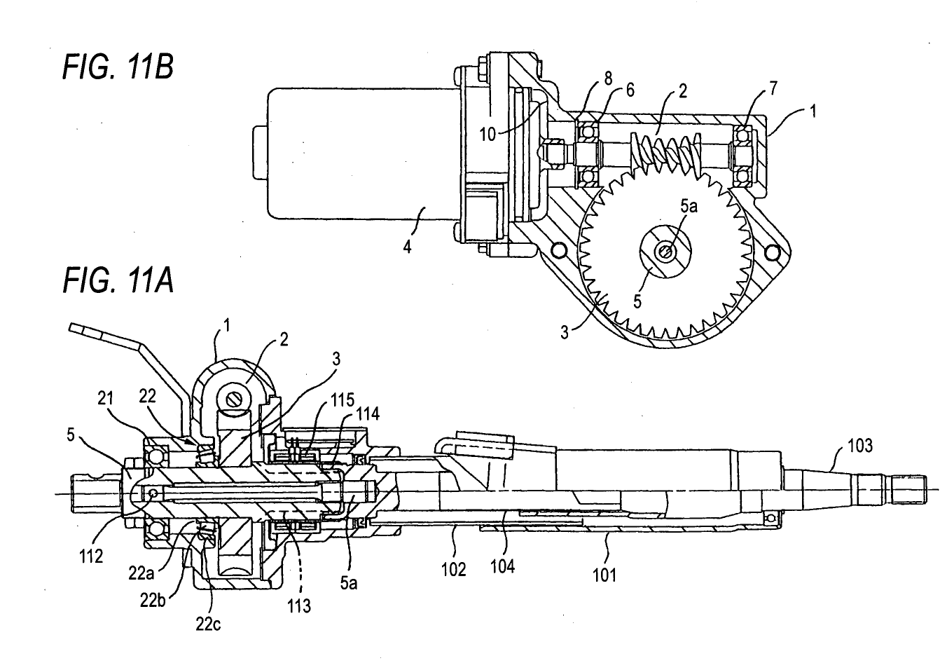

FIG. 1A is a longitudinal sectional view of a column assist electric power steering according to a ninth embodiment of the present invention, and FIG. 11B is a sectional view showing a pertinent portion of a worm gear system of the electric power steering.

In the column assist electric power steering shown in FIG. 11A, a lower column 102 is fitted into an upper column 101 of the steering column on the front side of the vehicle, and an upper shaft 103 and a lower shaft 104 (input shaft), both being spline-coupled, of the steering shaft are supported rotatably in these columns 101, 102.

The output shaft 5 is coupled to the lower shaft 104 (input shaft) on the front side of the vehicle. The steering gear (not shown) is coupled to the output shaft 5 on the front side of the vehicle via the universal joint (not shown), or the like.

A base end of the torsion bar 5a is press-fitted and fixed to the lower shaft 104 (input shaft) on the front side of the vehicle. The torsion bar 5a is extended through a hollow inner side of the output shaft 5, and its top end is fixed to an end portion of the output shaft 5 by a fixing pin 112.

A groove 113 for a torque sensor is formed in the output shaft 5 on the rear side of the vehicle, and a sleeve 114 of the torque sensor is arranged on the outside of the groove 113 in the diameter direction. A side end portion of this sleeve 114 on the rear side of the vehicle is fixed to the side end portion of the lower shaft 104 (input shaft) on the front side of the vehicle by the caulking, or the like. A coil 115, a substrate, etc. are provided on the outside of the sleeve 114 in the diameter direction.

The worm wheel 3 that is meshed with the hourglass worm 2 as the driving shaft of the electric motor 4 is fitted to the output shaft 5.

Therefore, a steering force generated when the driver turns a steering wheel (not shown) can be transmitted to the turning wheel (not shown) of the vehicle via the input shaft 104, the torsion bar 5a, the output shaft 5, and the rack-and-pinion steering equipment. Also, a turning force of the electric motor 4 is transmitted to the output shaft 5 via the hourglass worm 2 and the worm wheel 3. Thus, the assist steering torque can be applied to the output shaft 5 by controlling appropriately the turning force and the turning direction of the electric motor 4.

In the ninth embodiment, one bearing 21 for bearing the output shaft 5 (wheel 3) is composed of the ball bearing, and the other bearing 22 for bearing the output shaft 5 (wheel 3) is composed of the tapered roller bearing 22 from which an outer ring 22c can be separated and which can supports both the radial force and the thrust force.

In the fitting operation, an inner ring 22a and rolling elements 22b are fitted onto the output shaft 5 (wheel 3), and the outer ring 22c is fitted previously into the gear housing 1.

Then, the output shaft 5 (wheel 3) is moved obliquely to the rotating shaft line of the output shaft 5 (wheel 3) in the gear housing 1 along the raceway of the outer ring 22c. Thus, the tapered roller bearing 22 is assembled in the gear housing 1.

Here the angular contact bearing or the magneto ball bearing, from which its outer ring can be separated, may be employed in place of the tapered roller bearing 22.

### Tenth Embodiment

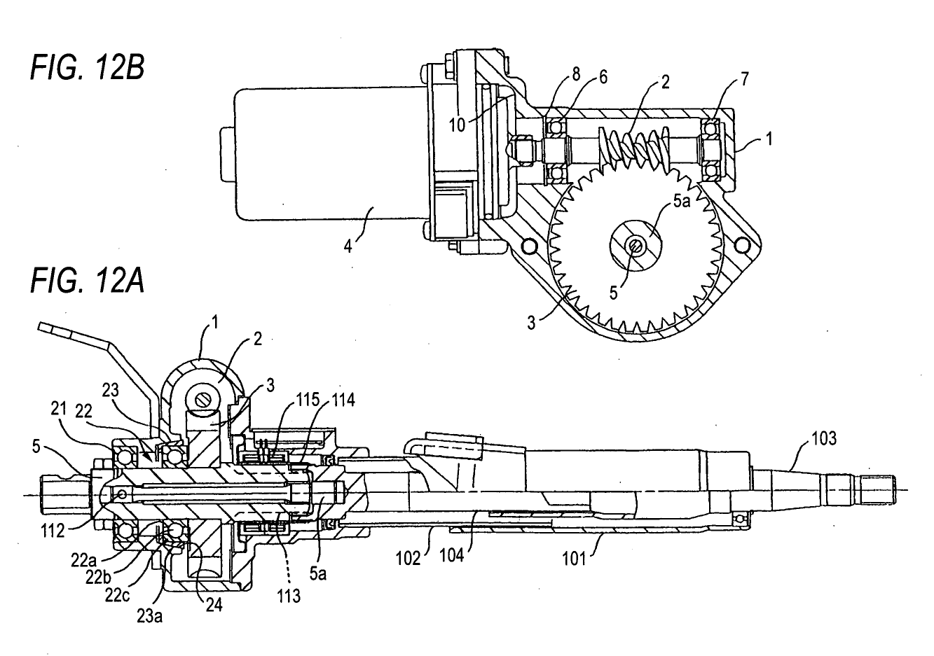

FIG. 12A is a longitudinal sectional view of a column assist electric power steering according to a tenth embodiment of the present invention, and FIG. 12B is a sectional view showing a pertinent portion of a worm gear system of the electric power steering.

In the tenth embodiment, the other bearing 22 for bearing the output shaft 5 (wheel 3) is composed of the deep groove ball bearing 22, and a cylindrical bearing holder 23 having a taper surface 23a on its outer peripheral surface is put on the outer ring 22c of the deep groove ball bearing 22.

A taper hole 24 with which the taper surface 23a of the bearing holder 23 is engaged is formed in the gear housing 1.

Therefore, in the fitting operation of the output shaft 5 (wheel 3), the output shaft 5 (wheel 3) is inserted while sliding the taper surface 23a of the bearing holder 23 along the taper hole 24 in the gear housing 1. In other words, the fitting of the output shaft 5 (wheel 3) into the bearing 22 (deep groove ball bearing) can be applied in the oblique direction to the rotating shaft line of the output shaft 5 (wheel 3).

### Eleventh Embodiment

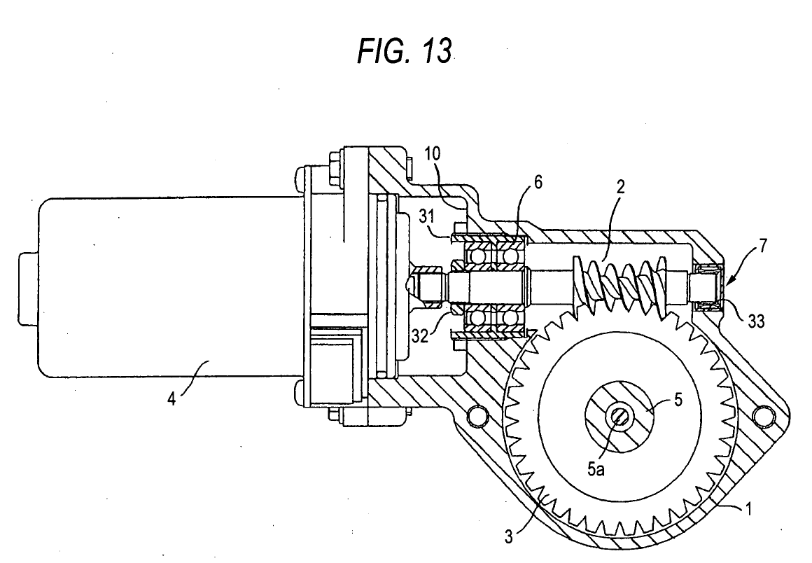

FIG. 13 is a longitudinal sectional view of an electric power steering according to an eleventh embodiment of the present invention.

In the conventional configuration in regard to JP-A-9-132154, since the wheel cannot help being fitted after the hourglass worm was assembled, the wheel must be shaped into the helical gear profile to eliminate the interference caused in the fitting operation. Although the number of working teeth is increased by employing the hourglass worm, the hourglass worm comes into contact with the wheel via a point contact. As a consequence, an effect of increasing a contact area could not be sufficiently achieved.

In light of such situation, in the eleventh embodiment, a double-bearing structure that can support the radial load and the bilateral thrust load is employed as the bearing 6 of the hourglass worm 2 on the motor side, and also such structure can be adjusted to move back and forth in the axial direction. More particularly, as shown in FIG. 13, a longitudinal-movement adjusting threaded member 31 is provided such that the member is screwed into the gear housing 1 to hold two bearings 6 therein. A nut 32 is screwed on the hourglass worm 2 side.

In contrast, the bearing 7 on the shaft end side is composed of a one-end-closed needle roller bearing. The bearing can be fitted into a fitting hole 33 provided in the end portion of the gear housing 1 from the outside of the gear housing 1 to seal the gear housing tightly.

With the above, the contact ratio can be improved by using the hourglass worm 2 to attain the higher output. Also, the misalignment can be corrected readily by simplifying considerably the fitting operation of the hourglass worm 2.

### Twelfth Embodiment

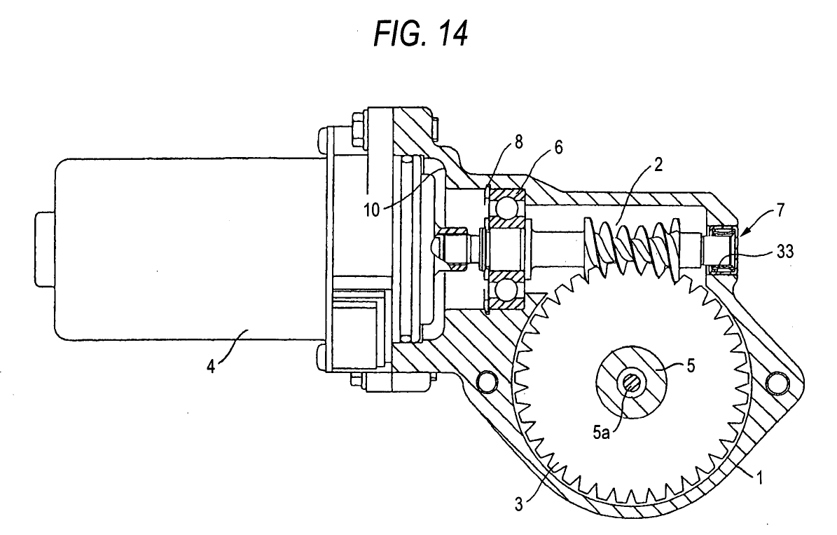

FIG. 14 is a longitudinal sectional view of an electric power steering according to a twelfth embodiment of the present invention.

In the twelfth embodiment, a four-point-contact ball bearing that does not need the preload is provided as the bearing 6 of the hourglass worm 2 on the motor side. Thus, the positional adjustment can be eliminated.

In contrast, the bearing 7 on the shaft end side is composed of the one-end-closed needle roller bearing. The bearing can be fitted into the fitting hole 33 provided in the end portion of the gear housing 1 from the outside of the gear housing 1 to seal the gear housing tightly.

With the above, not only the contact ratio can be improved by using the hourglass worm 2 to attain the higher output, but also the misalignment can be corrected readily by making the fitting operation of the hourglass worm 2 remarkably easy.

### Thirteenth Embodiment

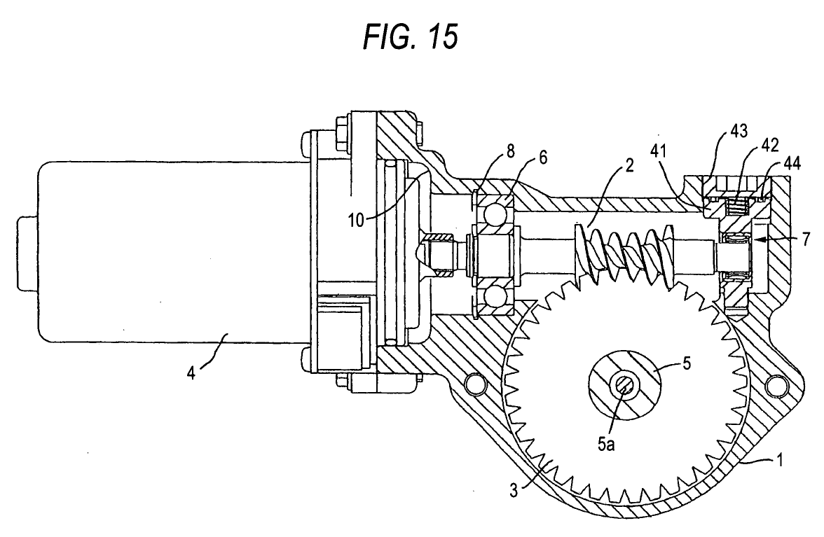

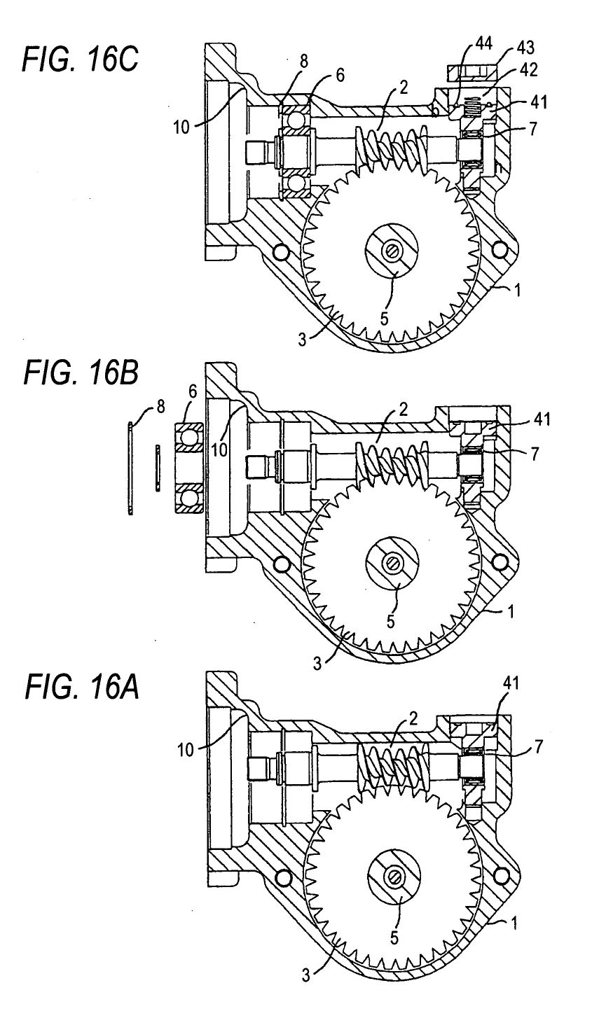

FIG. 15 is a longitudinal sectional view of an electric power steering according to a thirteenth embodiment of the present invention. FIGS. 16A to 16C are schematic views showing a fitting step of the electric power steering according to the thirteenth embodiment respectively.

The thirteenth embodiment is characterized in that the bearing 7 on the shaft end side is provided such that its position can be adjusted with respect to the gear housing 1 in the center-to-center direction.

More particularly, the bearing 7 on the shaft end side is composed of the one-end-closed needle roller bearing. A center-to-center distance adjusting member 41 is fitted on the one-end-closed needle roller bearing 7. A screw member 43 is screwed into the gear housing 1 to push the center-to-center distance adjusting member 41 via an elastic body 42 such as a spring, a rubber, a resin, or the like. Accordingly, the one-end-closed needle roller bearing 7 and the center-to-center distance adjusting member 41 are energized elastically toward the wheel 3 side.

In the fitting operation, as shown in FIG. 16A, the one-end-closed needle roller bearing 7 is fitted onto the hourglass worm 2, then the center-to-center distance adjusting member 41 is fitted on the one-end-closed needle roller bearing 7, and then the hourglass worm 2, and the like are inserted into the gear housing 1 in a state that the center-to-center distance is kept sufficiently large not to interfere with the wheel 3.

Then, as shown in FIG. 16B, the center-to-center distance adjusting member 41 is pushed into the gear housing 1. Thus, the hourglass worm 2 and the one-end-closed needle roller bearing 7 are moved toward the wheel 3 in their engaging position, and then fitted. At the same time, the bearing 6 on the motor side is also fitted. Finally, as shown in FIG. 16C, the screw member 43 is screwed.

In this manner, the one-end-closed needle roller bearing 7 on the shaft end side of the hourglass worm 2 is set such that the bearing can be moved with respect to the gear housing 1 in the wheel 3 direction. Thus, the hourglass worm 2 can be brought close to the wheel 3 side after such hourglass worm 2 is fitted into the one-end-closed needle roller bearing 7. As a result, the bearing 7 on the shaft end side can be provided in such a way that its position can be adjusted with respect to the gear housing 1 in the center-to-center direction.

With the above, the contact ratio can be improved by using the hourglass worm 2 to achieve the higher output. Also, the misalignment can be corrected easily by simplifying considerably the fitting operation of the hourglass worm 2.

Here a buffering O ring 44 is provided between the center-to-center distance adjusting member 41 and the screw member 43.

In this case, the present invention is not limited to the above embodiments, and the present invention may be varied variously. More specifically, the magneto ball bearing may be employed instead of the tapered roller bearing or the angular contact bearing.

### Fourteenth Embodiment

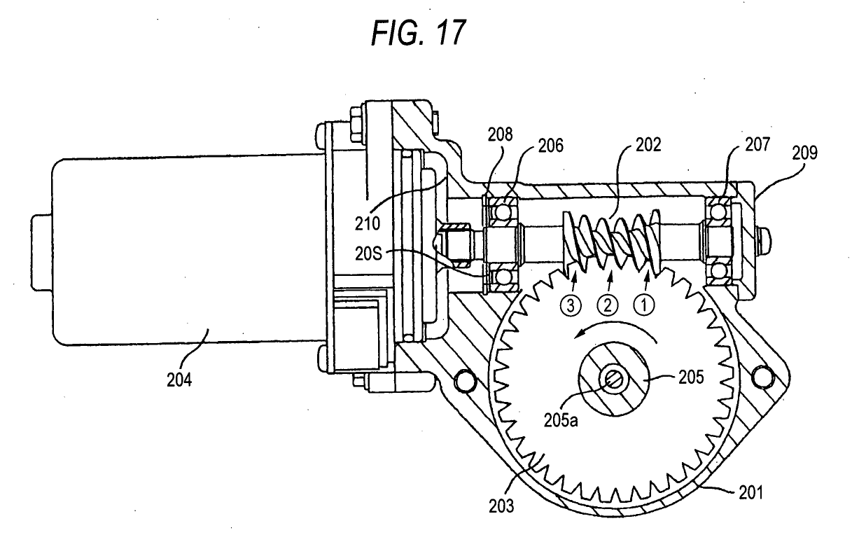

FIG. 17 is a longitudinal sectional view of an electric power steering according to a fourteenth embodiment of the present invention.

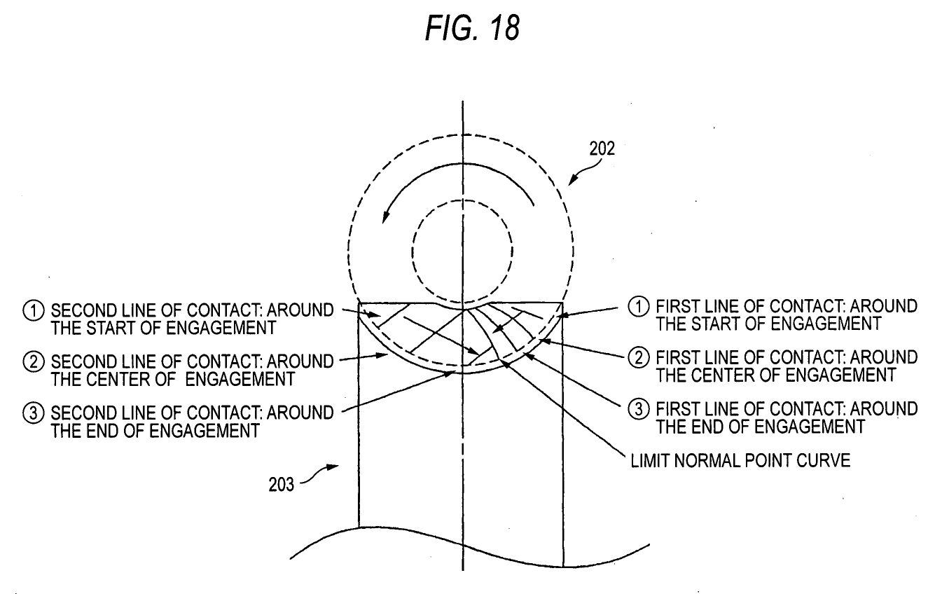

FIG. 18 is a state diagram of a line of contact in the electric power steering according to the fourteenth embodiment of the present invention.

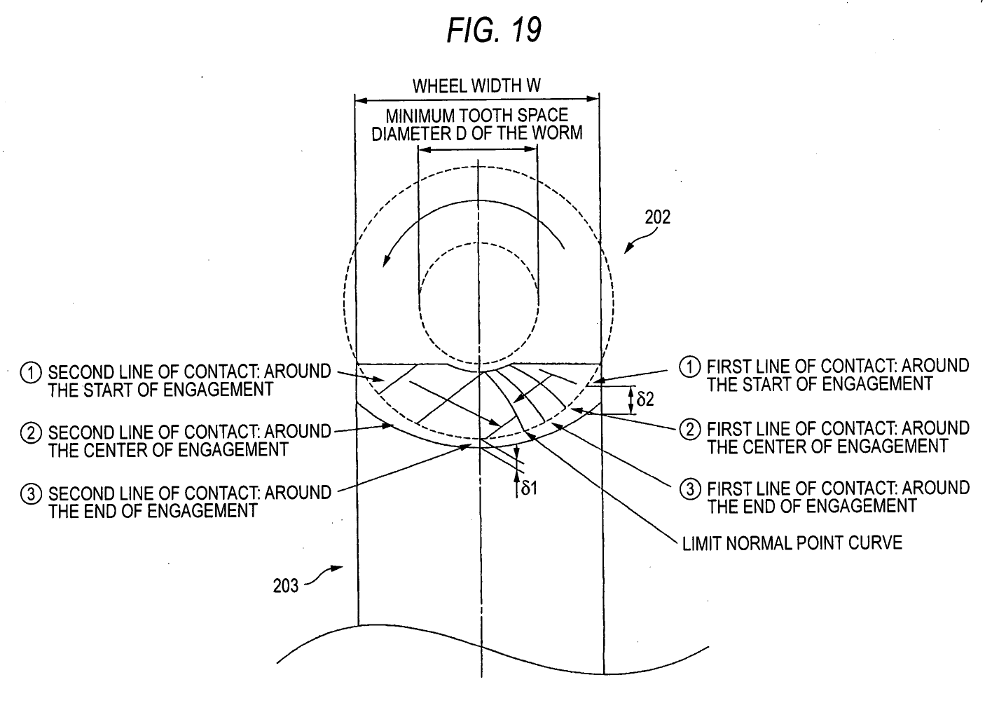

FIG. 19 is a view showing relationships among a clearance and a worm root diameter and a wheel tooth thickness in the electric power steering according to the fourteenth embodiment of the present invention.

In the fourteenth embodiment, a hourglass worm 202 and a worm wheel 203 that is meshed with this hourglass worm 202 are installed into a gear housing 201 of the worm gear system, and an electric motor 204 for driving the hourglass worm 202 is attached to the side portion of the gear housing 201. The worm wheel 203 is fitted onto an output shaft 205 (e.g., a pinion shaft or a column shaft) of the steering equipment. Therefore, the assist steering torque is generated from the electric motor 204 in response to the steering torque applied to the steering wheel (not shown), and then is transmitted to the output shaft 205 of the steering equipment via the reduction gear that consists of the hourglass worm 202 and a worm wheel 203. In this case, a reference symbol 205a denotes a torsion bar.

Also, owing to the interference of the pitch circles, the hourglass worm 202 cannot be fitted in the same way as the cylindrical worm. Therefore, bearings 206, 207 are fitted from both end sides in the situation that the hourglass worm 202 is meshed with the worm wheel 203. In other words, the bearings 206, 207 that bear rotatably both end portions of the hourglass worm 202 are fitted such that their positions can be adjusted by using a shim 20S (motor fitting hole 210 side) and a cover 209 (shaft end side) respectively. The misalignment can be corrected by adjusting the end surface positions of the bearings 206, 207 by virtue of the end surface positions of the shim 20S and the cover 209, or the like. Here a reference symbol 208 denotes a snap ring. This is common in all embodiments described in the following.

In the fourteenth embodiment, as shown in FIG. 18, the tooth profiles of the worm 202 and the wheel 203 are modified from the involute tooth profiles to special tooth profiles. According to the special tooth profiles, the tooth surface of the wheel 203 and the tooth surface of the worm 202 contact mutually at two locations of a first line of contact and a second line of contact, which intersect with each other and intersect with the sliding direction of the worm 202, in the tooth trace direction of the wheel 203, and a tooth surface of an intermediate gear is shaped into the conical surface.

As the worm reduction gear having this tooth profile, there are the product (trademark: HIDECON) of Sumitomo Heavy Industries, Ltd., the product (trademark: HICRA) of Shin-Ei Manufacturing Co., Ltd, and so forth. These products are used in general industries and heavy construction machinery applications, and the oil lubrication is applied.

In the engagement of these tooth profiles, the line of contact appears on both end sides in the tooth trace direction of the wheel 203 and on the addendum side in the tooth depth direction at the start time of engagement, while the line of contact moves to the center portion in the tooth trace direction of the wheel 203 and on the dedendum side in the tooth depth direction at the end time of engagement.

A point at which two lines of contact intersect with each other gives a limit normal point, and a line obtained by connecting these points gives a limit normal point curve.

The tooth profiles can mesh with each other such that the grease as the lubricant is gathered up toward the limit normal point curve near the center in the tooth trace direction according to two lines of contact. Therefore, the lubricant is not carried out of the wheel 203, and most of the lubricant can be held within the face width of the wheel 203.

As a result, in the electric power steering to which the lubricant is not supplied in the course of use, it is possible to prevent the degradation of the durability due to the lubrication failure in a long-term use.

In order to provide a line of contact directed in the tooth depth direction that intersects with the sliding direction of the worm 202, the worm takes the hourglass profile since a pressure angle of the tooth surface of the worm 202 to the rotating shaft of the worm 202 is changed continuously according to the rotating position of the wheel 203.

Consequently, the number of simultaneously contacting/working teeth can be increased, and an effect of reducing the face pressure can be achieved at the same time like the prior art, and also an oil film necessary for the lubrication can be thinned. As a result, such effects can be further enhanced.

Also, if the grease having a poor fluidity and a consistency of 385 or less is employed, such effects can also be further enhanced.

In addition, the grease that is gathered up to the dedendum side in the center of the face width of the wheel 203 by an action of the line of contact is carried to both end sides of the wheel 203 by a relative sliding motion between the top of the worm 202 and the bottom of the wheel 203 generated by the rotation of the top of the worm 202. Then, the grease is returned to the addendum side by the rotation of the wheel 203 to circulate.

However, as shown in FIG. 18, if a clearance between the top of the worm 202 and the bottom of the wheel 203 is set constant, an amount of the grease that is carried out of the tooth surface of the wheel 203 by the rotational motion of the worm 202 is increased due to the viscosity of the grease.

Therefore, as shown in FIG. 19, if the clearances (δ1, δ2) are increased toward the end portion of the wheel 203, a moving power of the grease due to the viscous resistance can be lessened toward both ends of the wheel 203. Therefore, an amount of the grease that is carried out of the face width of the wheel 203 can be reduced, and thus the grease can be retained more effectively within the face width of the wheel 203.

Also, in order to increase an amount of the grease that can be held within the face width of the wheel 203 (to decrease an amount of the grease that is carried out of the wheel 203), it is desired that the face width of the wheel 203 should be set larger than a minimum tooth space diameter of the worm 202.

### Fifteenth Embodiment

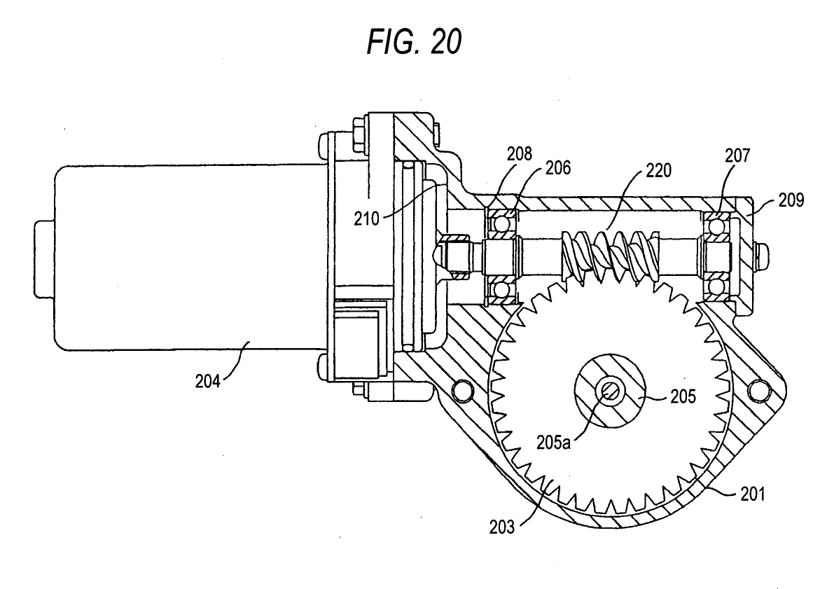

FIG. 20 is a longitudinal sectional view of an electric power steering according to a fifteenth embodiment of the present invention.

In contrast to the fourteenth embodiment, in the fifteenth embodiment, as shown in FIG. 20, the top side of a worm 220 is formed as a cylindrical shape.

In the fourteenth embodiment, both ends of the hourglass worm 202 are increased in diameter and the gear housing 201 is increased in size, and thus the fitting performance becomes worse. Also, the circulation of the grease becomes difficult toward both ends of the tooth trace direction of the wheel 203 and on the top side.

However, in the fifteenth embodiment, as shown in FIG. 20, the top side of the worm 220 is formed as the cylindrical shape. Therefore, the engagement on both ends of the wheel 203 and on the top side can be lessened, and thus the durability can be further improved.

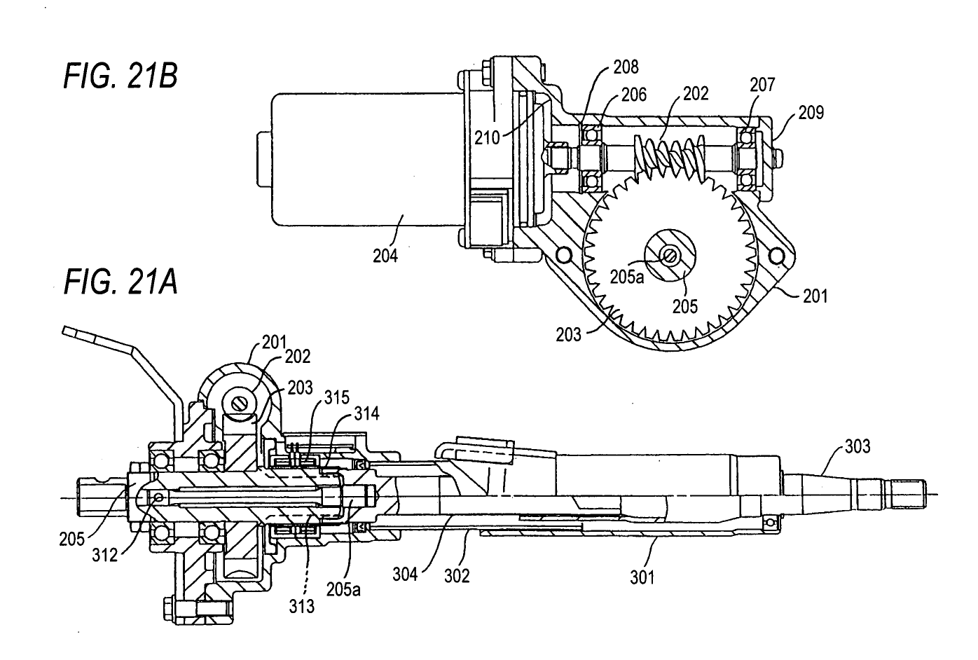

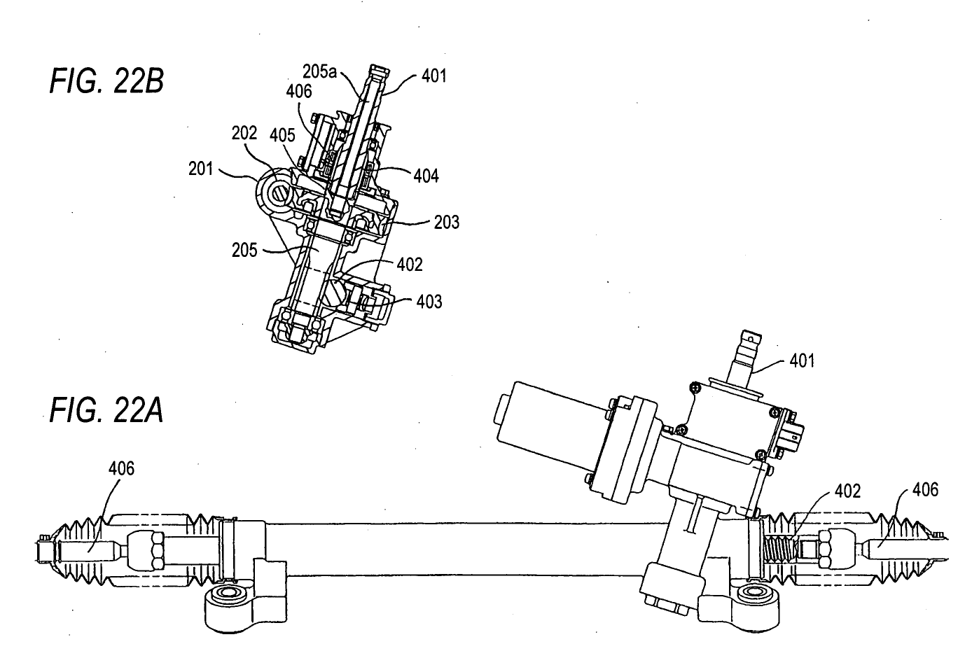

Here the present invention is not limited to the above embodiments, and can be varied variously. For example, as the type of the EPS, as shown in FIG. 21A, the column assist type (the turning force of the motor is reduced via the reduction gear to power/energize the column shaft) may be employed and also, as shown in FIG. 22A, the pinion assist type (the turning force of the motor is reduced via the reduction gear to power/energize the pinion shaft) may be employed.

More particularly, FIG. 21A is a longitudinal sectional view of a column assist electric power steering according to the present invention, and FIG. 21B is a sectional view showing a pertinent portion of a worm gear system of the electric power steering.

In the column assist electric power steering shown in FIG. 21A, a lower column 302 is fitted into an upper column 301 of the steering column on the front side of the vehicle. An upper shaft 303 and a lower shaft 304 (input shaft), which are spline-coupled, of the steering shaft are supported rotatably in these columns 301, 302.

The output shaft 205 is coupled to the lower shaft 304 (input shaft) on the front side of the vehicle. The steering gear (not shown) is coupled to this output shaft 205 on the front side of the vehicle via the universal joint (not shown), or the like.

The base end of the torsion bar 205a is press-fitted and fixed to the lower shaft 304 (input shaft) on the front side of the vehicle. The torsion bar 205a is extended through a hollow inner side of the output shaft 205, and its top end is fixed to an end portion of the output shaft 5 by a fixing pin 312.

A groove 313 for the torque sensor is formed in the output shaft 205 on the rear side of the vehicle, and a sleeve 314 of the torque sensor is arranged on the outside of the groove 313 in the diameter direction. The side end portion of this sleeve 314 on the rear side of the vehicle is fixed to the side end portion of the lower shaft 304 (input shaft) on the front side of the vehicle by the caulking, or the like. A coil 315, a substrate, etc. are provided on the outside of the sleeve 314 in the diameter direction.

The worm wheel 203 that is meshed with the hourglass worm 202 as the driving shaft of the electric motor 204 is fitted to the output shaft 205.

The steering force generated when the driver turns the steering wheel (not shown) can be transmitted to the turning wheel (not shown) of the vehicle via the input shaft 304, the torsion bar 205a, the output shaft 205, and the rack-and-pinion steering equipment. Also, the turning force of the electric motor 204 is transmitted to the output shaft 205 via the hourglass worm 202 and the worm wheel 203. Thus, the assist steering torque can be applied to the output shaft 205 by controlling appropriately the turning force and the turning direction of the electric motor 204.

Then, FIG. 22A is a front view containing a partially sectioned cross section of a pinion assist electric power steering according to the present invention, and FIG. 22B is a sectional view showing a pertinent portion of the electric power steering.

In the pinion assist electric power steering, the output shaft 205 (pinion shaft) is coupled to a lower shaft 401 (input shaft) on the front side of the vehicle. A rack 402 of the steering gear is meshed with the output shaft 205 (pinion shaft). The rack 402 is energized elastically by an elastic body 403, or the like and is pushed against the output shaft 205 (pinion shaft) all the time.

A base end of the torsion bar 205a is press-fitted and fixed to the output shaft 205. The torsion bar 205a is extended through a hollow inner side of the input shaft 401, and its top end is fixed to an end portion of the input shaft 401.

A groove 404 for a torque sensor is formed in the input shaft 401 on the front side of the vehicle, and a sleeve 405 of the torque sensor is arranged on the outside of the groove 404 in the diameter direction. A coil 406, a substrate, etc. are provided on the outside of the sleeve 405 in the diameter direction.

The worm wheel 203 that is meshed with the hourglass worm 202 as the driving shaft of the electric motor 204 is fitted to the output shaft 205.

Therefore, the steering force generated when the driver turns the steering wheel (not shown) can be transmitted to the turning wheel (not shown) of the vehicle via the input shaft 401, the torsion bar 205a, the output shaft 205, the rack-and-pinion steering equipment, a tie-rod 406, and the like. Also, the turning force of the electric motor 204 is transmitted to the output shaft 205 via the hourglass worm 202 and the worm wheel 203. Thus, the proper assist steering torque can be applied to the output shaft 205 by controlling appropriately the turning force and the turning direction of the electric motor 204.

Also, as the type of the electric motor 204, either a DC brush motor or a brushless motor may be employed.

The brushless motor can achieve higher the effect of the present invention than the brush motor.

In detail, because a brush resistance loss in the brush motor is not generated in the brushless motor, the brushless motor can get a better efficiency and a lower internal resistance, and thus an efficiency of the brushless motor is improved further as a high speed motor. In this case, a sliding speed of the worm to the worm wheel 203 is increased as the number of revolution of the worm 202 (220) in the reduction gear is increased. Therefore, when the brushless motor is used as the electric motor in the reduction gear, a reduction of the durability due to a lack of the grease becomes more conspicuous. As a result, the effect of the present invention can be further enhanced.

Also, in the first and fifteenth embodiments, the number of threads of the worm 202 (220) is set forth as two threads. But the effect of the present invention is not varied when three threads or one thread is employed.

### Sixteenth Embodiment

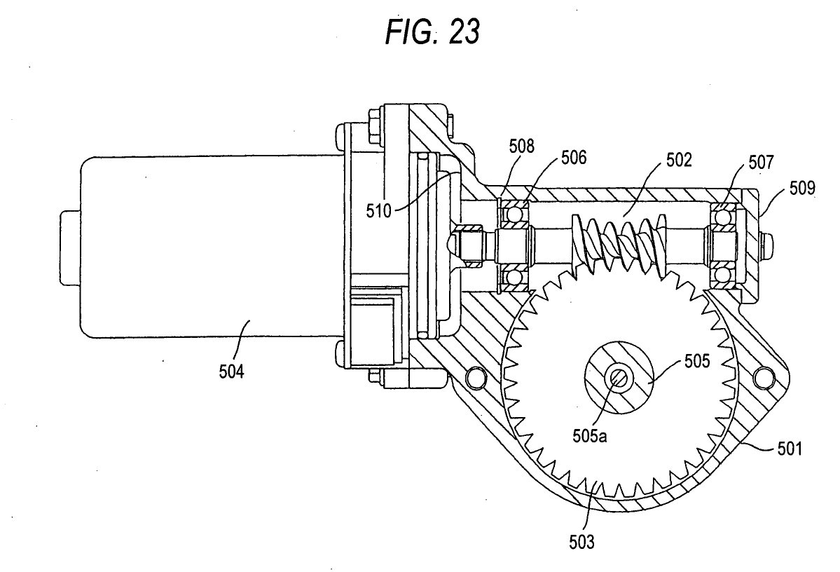

FIG. 23 is a longitudinal sectional view of an electric power steering according to a sixteenth embodiment of the present invention.

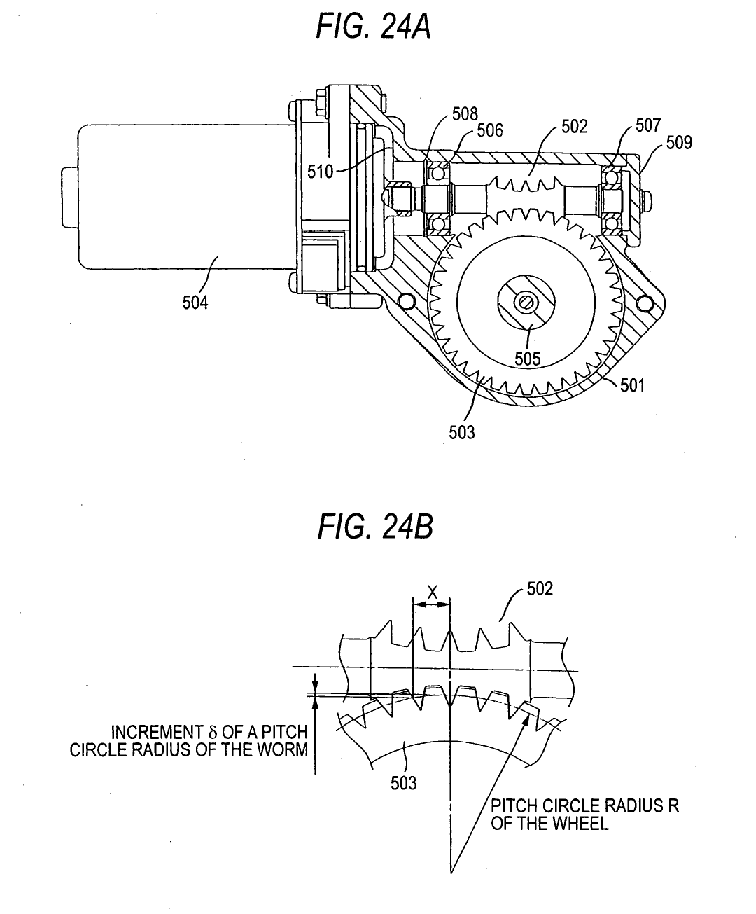

FIG. 24A is a longitudinal sectional view of the electric power steering shown in FIG. 23, and FIG. 24B is a schematic view showing a relationship between the pitch circle of the hourglass worm and the pitch circle of the wheel.

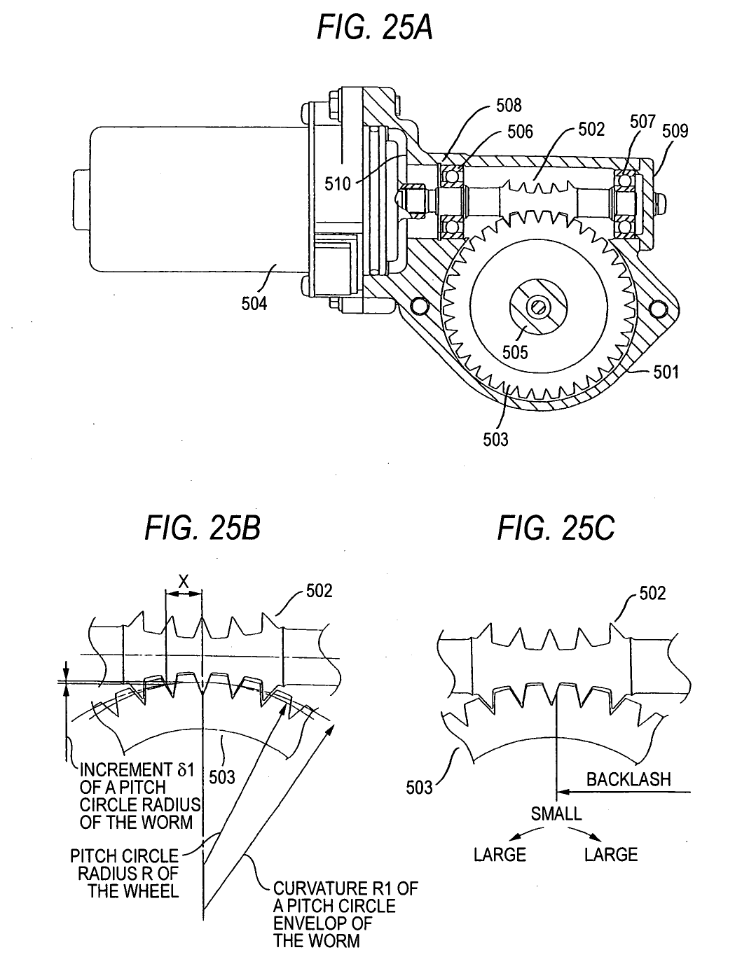

FIG. 25A is a longitudinal sectional view of the electric power steering shown in FIG. 23, FIG. 25B is a schematic view showing a relationship between a pitch circle envelope of the hourglass worm and the pitch circle of the wheel, and FIG. 25C is a schematic view showing an extent of the backlash.

As shown in FIG. 23, in the sixteenth embodiment, a hourglass worm 502 and a worm wheel 503 that is meshed with the hourglass worm 502 are installed into a gear housing 501, and an electric motor 504 for driving the hourglass worm 502 is mounted on the side portion of the gear housing 501. The worm wheel 503 is fitted onto an output shaft 505 (e.g., a pinion shaft or a column shaft) of the steering equipment. Accordingly, the assist steering torque is generated from the electric motor 504 in response to the steering torque applied to the steering wheel (not shown), and then transmitted the output shaft 505 of the steering equipment via the reduction gear that consists of the hourglass worm 502 and the wheel 503. Here, the reference numeral 505a denotes a torsion bar.

In the case of the hourglass worm 502, the same fitting way as the cylindrical worm cannot be applied owing to the interference of the pitch circles. Therefore, bearings 506, 507 are fitted from both end sides in the situation that the hourglass worm 502 is meshed with the wheel 503. In other words, the bearings 506, 507 for bearing rotatably both end portions of the hourglass worm 502 are fitted such that their positions can be adjusted by a snap ring 508 (motor fitting hole 510 side) and a cover 509 (shaft end side) respectively. The end surface positions of the bearings 506, 507 are adjusted by adjusting the end surface positions of the snap ring 508 and the cover 509, or the like, and thus the misalignment can be corrected.

By the way, as shown in FIG. 24B, in the case of the hourglass worm 502, a distance between the rotating shaft of the wheel 503 and the rotating shaft of the hourglass worm 502, both shafts being neither parallel nor intersecting, is increased from the shortest distance, which is given as a length of the common perpendicular line to both rotation shafts (center-to-center distance) in accordance with a rotation phase of the wheel 503.

Then, an increment a of the pitch circle radius of the hourglass worm 502 is given by
σ=R−\sqrt{R²−X²} [Formula 2]
where R is a pitch circle radius of the wheel 503, and
X is a distance from the common perpendicular line of the hourglass worm 502.

Therefore, the pitch circle diameter of the hourglass worm 502 is symmetrically increased continuously as a position X goes away from the position (X=0), on which the common perpendicular line is located and at which the minimum diameter is given, in the axial direction of the worm.

In contrast, suppose that an increment of the pitch circle radius of the hourglass worm 502 is σ1, a curvature of a pitch circle radius envelope of the hourglass worm 502 is R1, and a pitch circle radius of the wheel 503 is R (R1>R),
σ1=R1−\sqrt{R1²X²}<σ [Formula 3]
is satisfied. Here, R1 may be set as a constant and σ 1 may be set as a function that is increased in response to an increase of any X.

The interference between the pitch circle of the wheel 503 and the pitch circle of the hourglass worm 502 due to a positional displacement of the hourglass worm 502 is very small in the center portion of the hourglass worm 502 but becomes large on both end sides.

As shown in FIG. 25B, if a curvature of an envelope obtained by connecting the pitch circle of the hourglass worm 502 is set larger than a pitch circle radius of the wheel 502, the minimum backlash of the hourglass worm 502 is not increased but the backlash on both end sides of the hourglass worm 502 can be increased, as shown in FIG. 25C.

The interference between the tooth surfaces due to the misalignment can be prevented not to enlarge the touching sound of the tooth surface due to the backlash, and also a tolerance in the adjusting operation can be relaxed. Therefore, the productivity can be improved.

Also, the wheel 503 is formed to be flexible if at least the tooth portion of the wheel is made of a synthetic resin. Thus, the number of working teeth between the wheel 503 and the hourglass worm 502 can be increased sequentially in response to the transmission torque.

As a consequence, an increase of a contact pressure that is increased in answer to an increase of the transmission torque can be suppressed small by expanding a loading range, and also the abrasion durability can be improved.

In addition, if the number of threads of the hourglass worm 502 is increased, the number of working teeth at full load is increased. Therefore, an expansion of the loading range can be attained smoothly in response to the transmission torque and also an increase of the face pressure can be made smoother, and thus the abrasion durability can be improved.

Also, in the case of the hourglass worm 502, the hourglass worm 502 is not fitted in the same way as the cylindrical worm because the pitch circles interfere with each other. Thus, the bearings are fitted from both end sides in the situation that the hourglass worm 502 is meshed with the wheel 503. The misalignment is corrected by adjusting the end surface position of the bearing 506 by using the snap ring 508, or the like.

Also, in the reduction gear using the above EPS hourglass worm, an influence of an assembling error of the hourglass worm in the axial direction is exerted largely rather than the reduction gear using the cylindrical worm. In the cylindrical worm, the engagement is not varied depending on the worm position in the axial direction. In contrast, such a problem is raised that, if an assembling error of the hourglass worm in the axial direction becomes large in the hourglass worm, a margin of the engagement between the worm and the worm wheel is lost completely and then the frictional resistance that weakens the driving force is generated, i.e., the meshing confliction is generated in some portion.

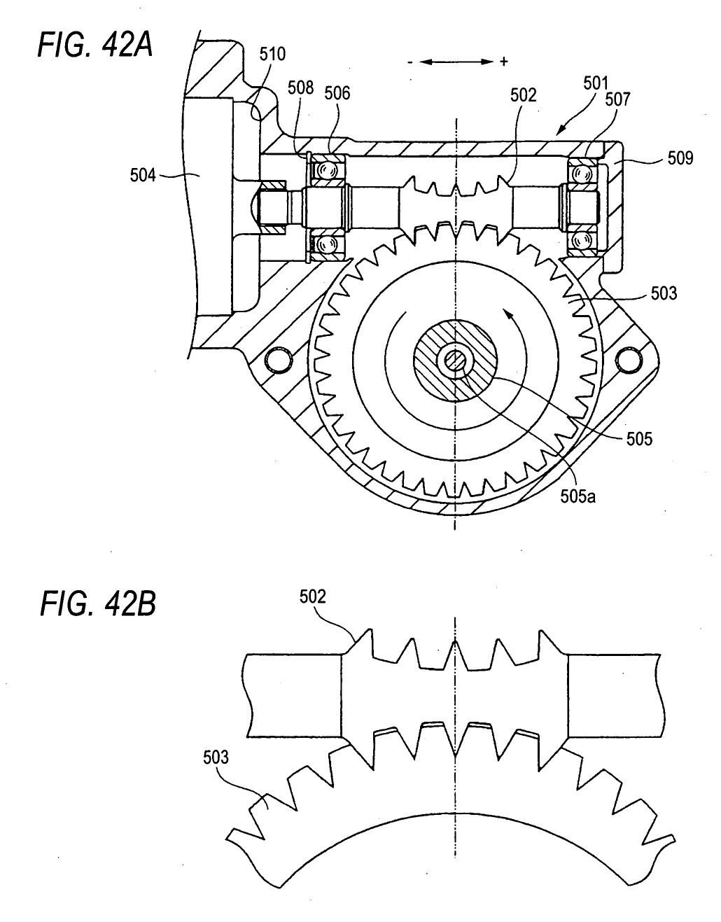

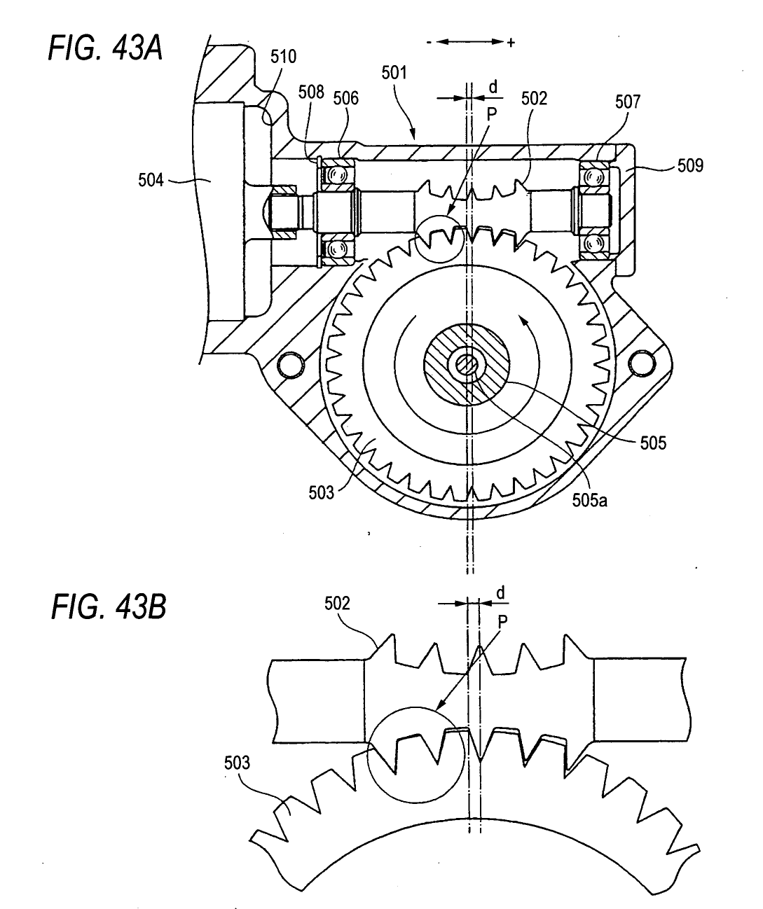

For example, it is apparent from FIG. 42B that no meshing confliction is generated in the engagement between the hourglass worm 502 and the worm wheel 503 shown in FIG. 42A. Here, assume that the right-hand side from a center of the shaft of the worm wheel 503 in FIG. 43A is set as the (+) direction and the left-hand side in FIG. 43A is set as the (−) direction. Then, as shown in FIG. 43A, if a fitting error d is generated due to a deviation of the fitting position of the hourglass worm 502 along the (+) direction of the axial direction, the meshing confliction is generated in the engagement between the hourglass worm 502 and the worm wheel 503 (portion indicated by P), as shown in FIG. 43B. Such influence is enhanced toward the (−) direction from the center of the worm 502.

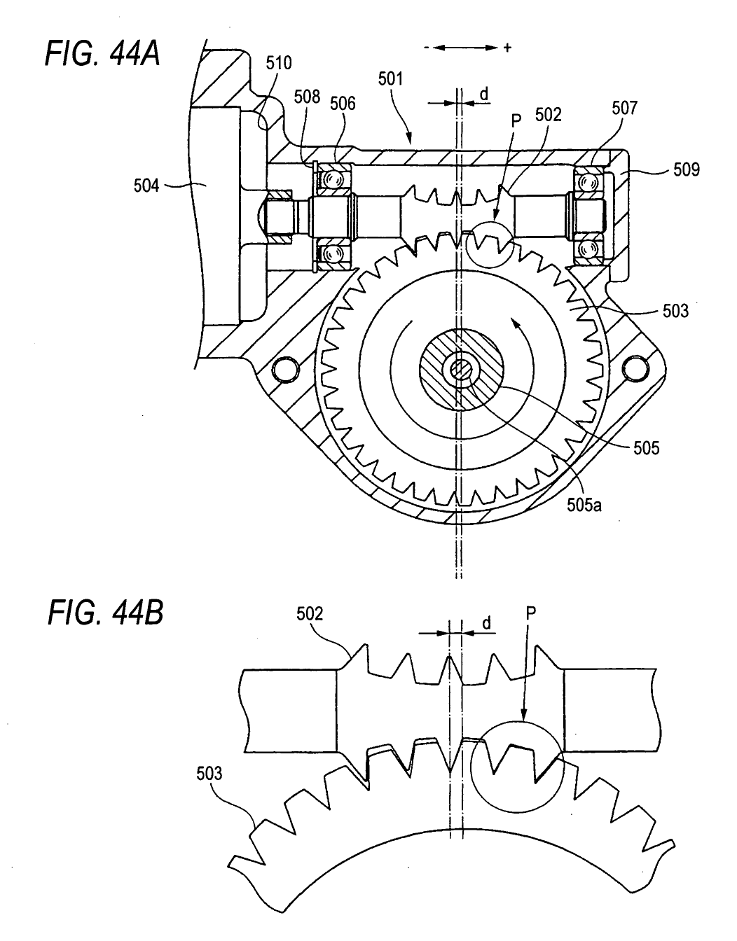

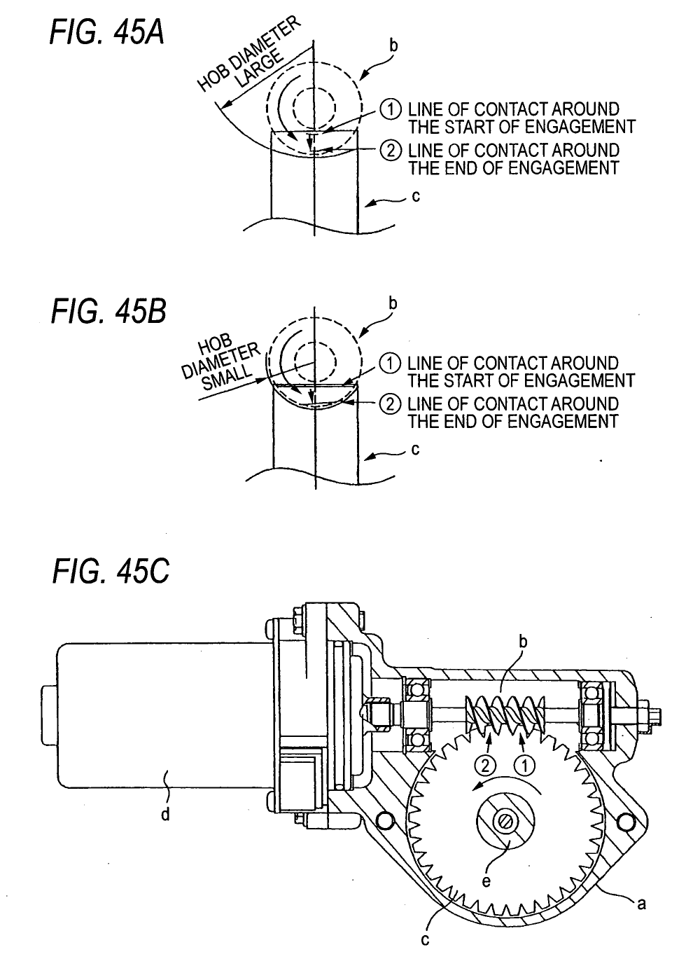

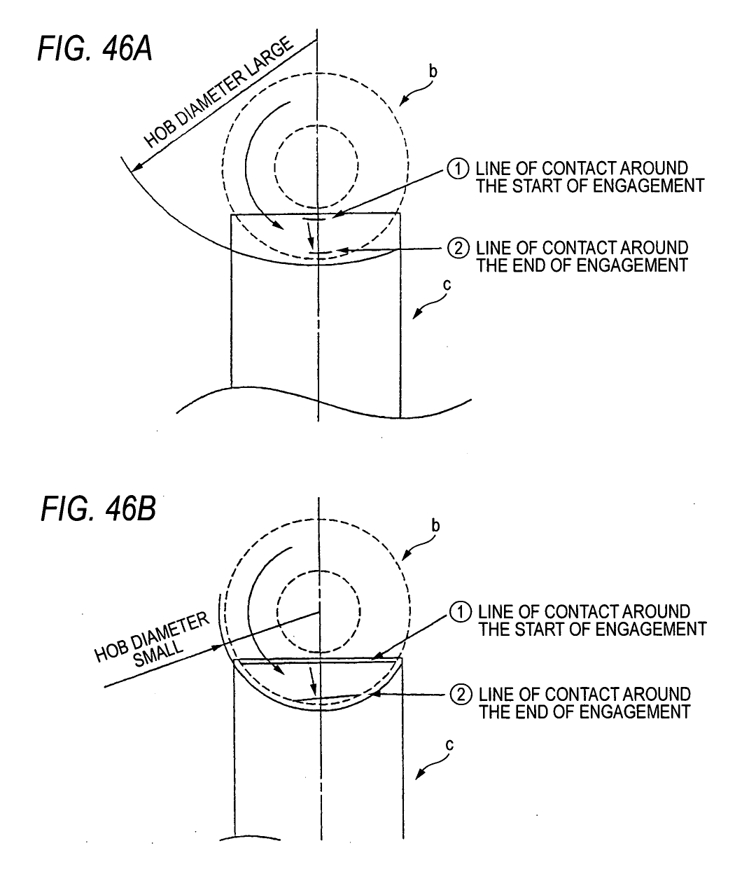

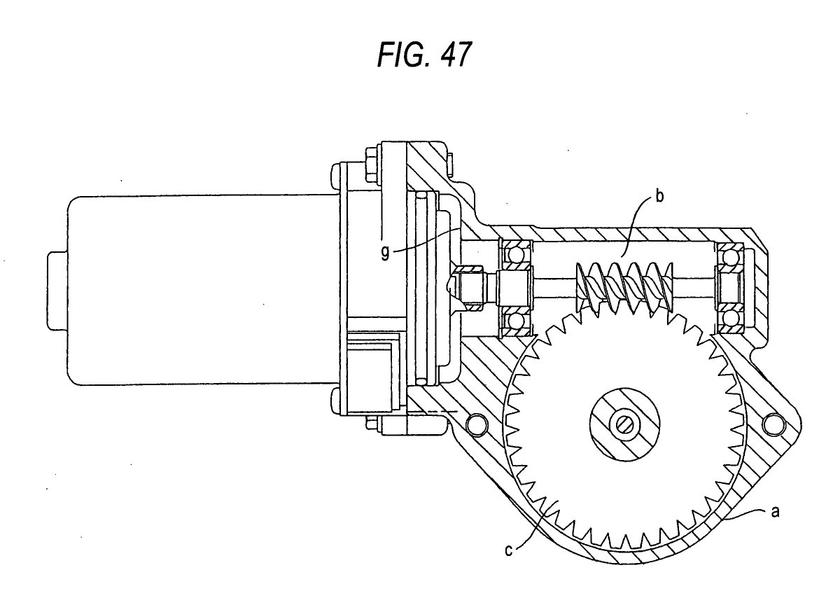

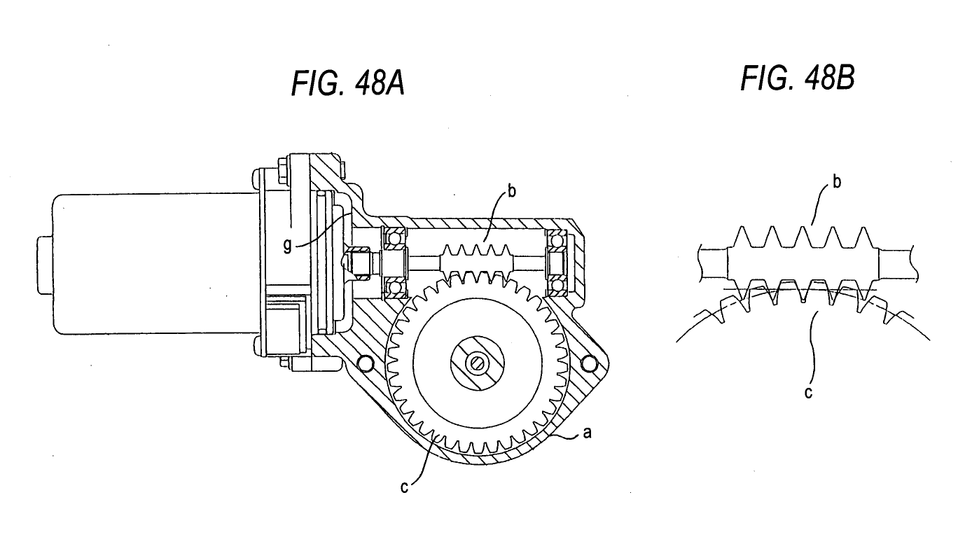

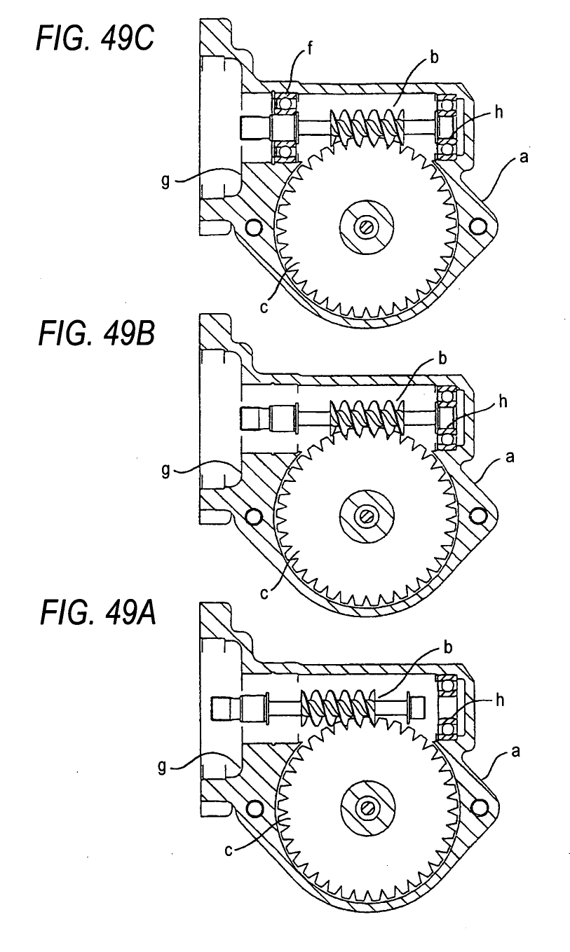

Similarly, as shown in FIG. 44A, if a fitting error d is generated due to a deviation of the fitting position of the hourglass worm 502 along the (−) direction of the axial direction, the meshing confliction is generated in the engagement (portion indicated by P), as shown in FIG. 43B. Such influence is enhanced toward the (+) direction from the center of the worm 502.

In this manner, when the meshing confliction is generated between the hourglass worm 502 and the worm wheel 503, such meshing confliction causes a defective operation, a reduction of the efficiency, etc. of the reduction gear, which leads to a reduction of the working efficiency of the EPS. As a result, such an disadvantage is caused that the turning-back of the steering wheel is worsened.

For this reason, in embodiments of the present invention described in the following, the electric power steering that is capable of suppressing the influences of the meshing confliction, and the like caused by the assembling error of the reduction gear using the hourglass worm in the worm axial direction to the utmost will be provided.

### Seventeenth Embodiment

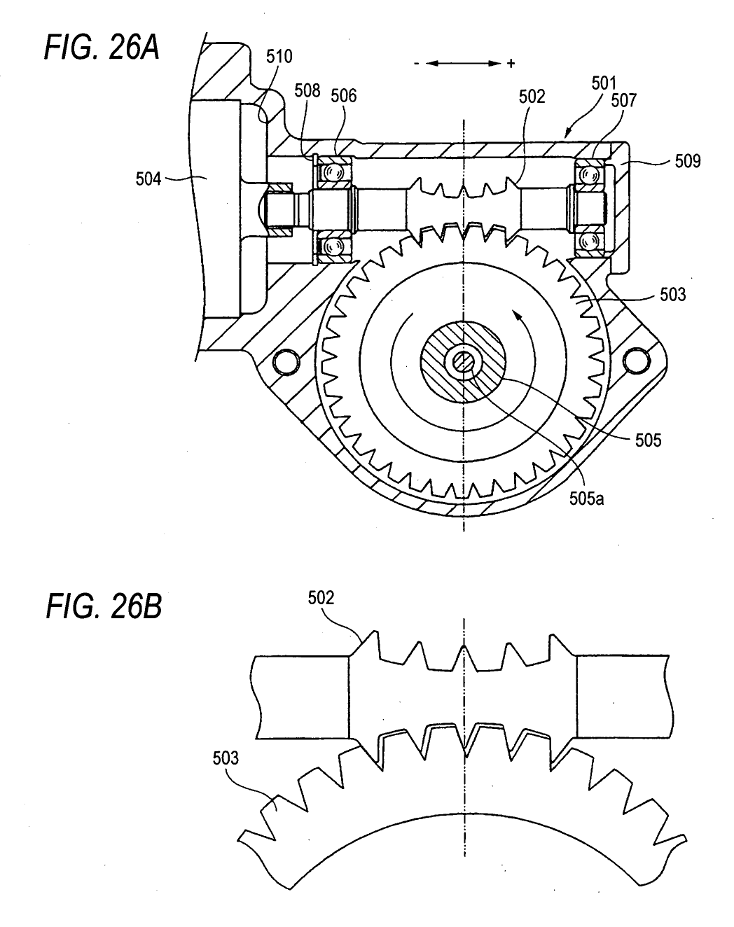

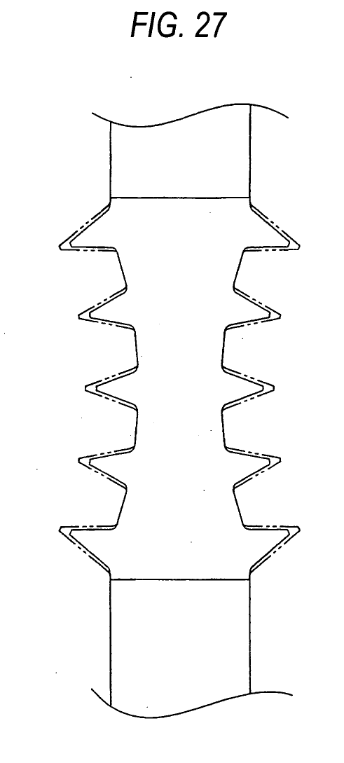

FIG. 26A is a longitudinal sectional view showing an hourglass worm reduction gear in an electric power steering according to a seventeenth embodiment of the present invention, and FIG. 26B is an enlarged view of an engaging portion. FIG. 27 is an enlarged view showing an hourglass worm in FIG. 26A.

As shown in FIG. 26A, in the seventeenth embodiment, the hourglass worm 502 and the worm wheel 503 that is meshed with the hourglass worm 502 are installed into the gear housing 501 of the worm gear system, and the electric motor 504 for driving the hourglass worm 502 is mounted on the side portion of the gear housing 501. The hourglass worm 502 is fitted rotatably in the gear housing 501 via the bearings 506, 507 fixed in the gear housing S01. The worm wheel 503 is fitted/fixed onto the output shaft 505 (e.g., the pinion shaft or the column shaft) of the steering equipment. The torsion bar 505a is fitted into the output shaft 505.

According to this configuration, the assist steering torque obtained by decelerating the driving force of the electric motor 504 via the hourglass worm 502 and the wheel 503 is generated in response to the steering torque applied to the steering wheel (not shown) and then transmitted the output shaft 505 of the steering equipment.

The hourglass worm 502 cannot be fitted in the same way as the cylindrical worm because the pitch circles interfere with each other. Therefore, the bearings 506, 507 are fitted from both end sides in the situation that the hourglass worm 502 is meshed with the worm wheel 503. In other words, the bearings 506, 507 are fitted such that their positions can be adjusted by the snap ring 508 (motor fitting hole 510 side) and the cover 509 (shaft end side) respectively. The end surface positions of the bearings 506, 507 are adjusted by adjusting the end surface positions of the snap ring 508 and the cover 509, or the like, and thus the misalignment can be corrected.

As shown in FIG. 27, the tooth thickness adjusting process is applied to a profile indicated by a broken line to reduce/thin each tooth thickness by an infinitesimal amount, and thus the hourglass worm 502 is shaped into a profile indicated by a solid line.

FIG. 26A shows the condition that the worm wheel 503 is turned CCW (counter-clockwise) by the input given by the direct action of the worm 502. In this condition, as shown in FIG. 26B, no meshing confliction is generated as a whole in the engagement between the hourglass worm 502 and the worm wheel 503.

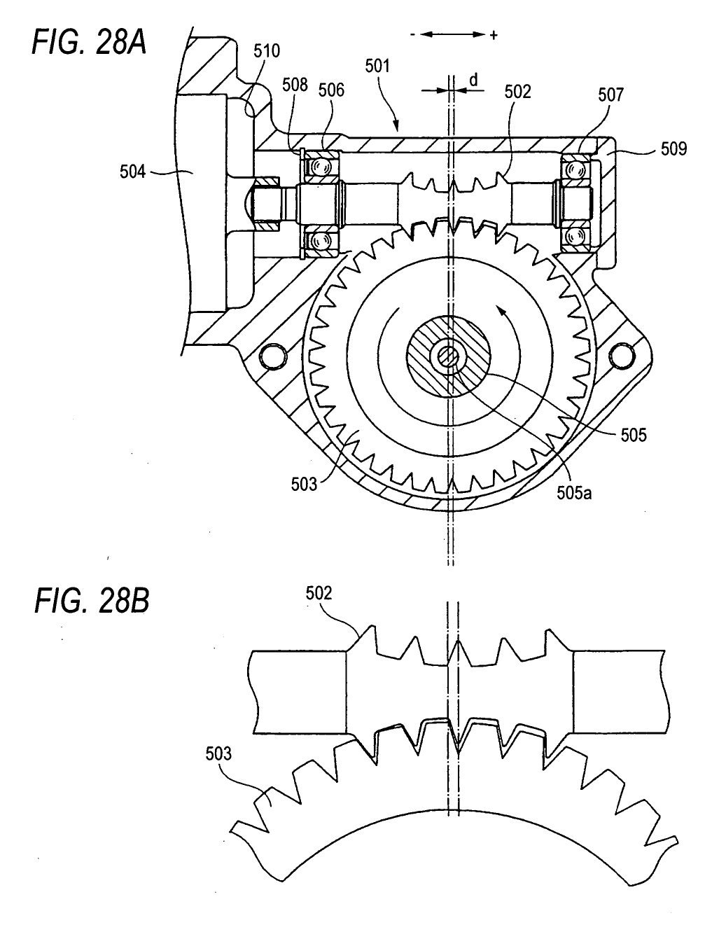

FIG. 27A is a longitudinal sectional view showing the reduction gear that contains the assembling error of the hourglass worm, to which the tooth thickness adjusting process is applied, in the axial direction (+ direction) and FIG. 27B is an enlarged view of an engaging portion. FIG. 28A is a longitudinal sectional view showing the reduction gear that contains the assembling error of the hourglass worm, to which the tooth thickness adjusting process is applied, in the axial direction (− direction) and FIG. 28B is an enlarged view of an engaging portion.

In the above configuration, assume that the right-hand side from the center of the shaft of the worm wheel 503 in FIG. 28A is set as the (+) direction and the left-hand side in FIG. 28A is set as the (−) direction, for example, when the assembling error is generated in the axial direction of the hourglass worm 502 upon assembling the reduction gear (worm gear system) Then, as shown in FIG. 28A, even though the fitting error is generated to deviate the fitting position of the hourglass worm 502 by a distance d along the (+) direction of the axial direction, the meshing confliction the influence of which is enhanced larger toward the (−) direction from the center of the worm 502 in the example in FIG. 43B can be suppressed to the lowest minimum in the engagement between the hourglass worm 502 and the worm wheel 503, as shown in FIG. 28B.

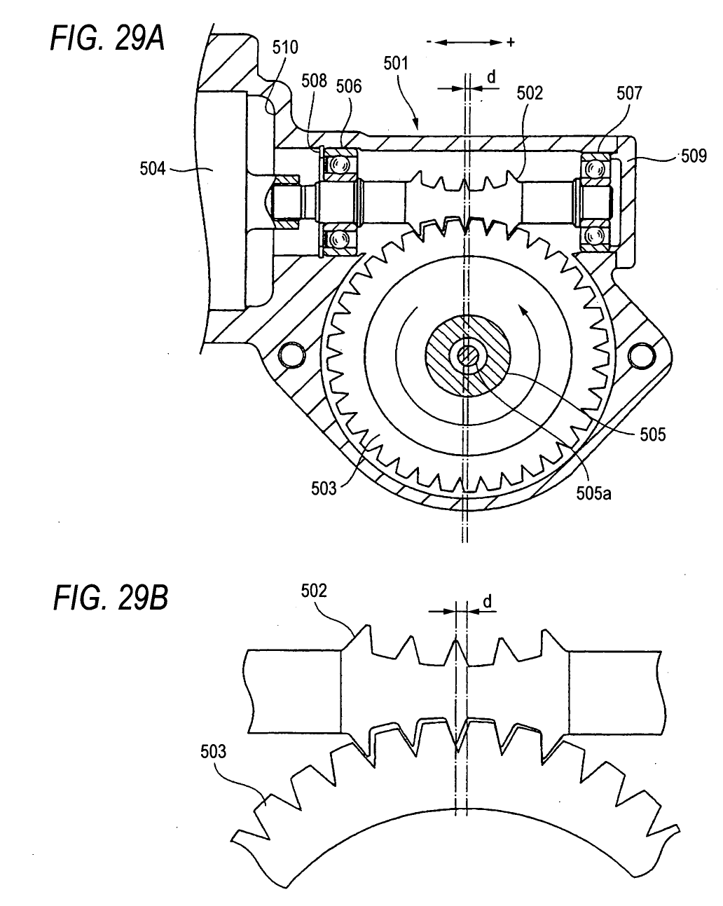

Similarly, as shown in FIG. 29A, even though the fitting error d is generated to deviate the fitting position of the hourglass worm 502 along the (−) direction of the axial direction, the meshing confliction the influence of which is enhanced larger toward the (+) direction from the center of the worm 502 in the example in FIG. 44B can be suppressed to the lowest minimum in the engagement, as shown in FIG. 29B.

As a consequence, even though the assembling error of the hourglass worm 502 in the axial direction is generated upon assembling the reduction gear, generation of the meshing confliction in the engagement between the hourglass worm 502 and the worm wheel 503 can be suppressed as small as possible since the tooth thickness adjusting process is applied to the hourglass worm 502. Also, a defective operation, a reduction of the efficiency, etc. of the reduction gear can be suppressed.

### Eighteenth Embodiment

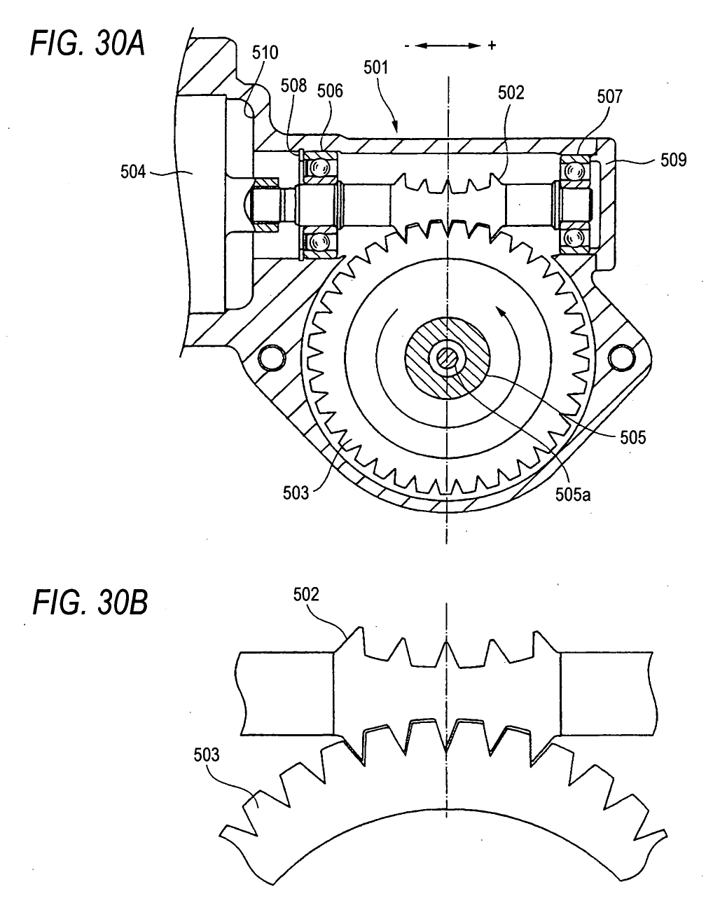

Next, an eighteenth embodiment of the present invention will be explained with reference to FIG. 30A to FIG. 34B hereunder.

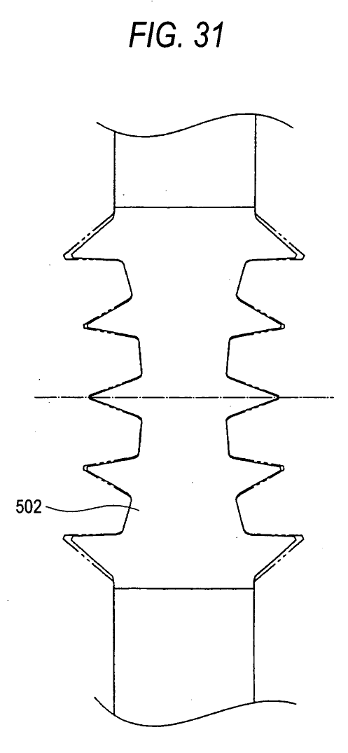

FIG. 30A is a longitudinal sectional view showing an hourglass worm reduction gear in an electric power steering according to an eighteenth embodiment of the present invention, and FIG. 30B is an enlarged view of an engaging portion. FIG. 31 is an enlarged view showing an hourglass worm in FIG. 30A.

The eighteenth embodiment is substantially similar to the above seventeenth embodiment, and the same reference numerals are affixed to the same members and parts as the above embodiment and thus their redundant explanation will be omitted herein. A difference between them resides in that, as shown in FIG. 30A and FIG. 31, the tooth thickness of the hourglass worm 502 is thinned gradually from the center to both end portions in the axial direction in the tooth thickness adjusting process. As shown in FIG. 31, the tooth profile of the hourglass worm 502 is shaped from a shape indicated by a broken line to a shape indicated by a solid line by the tooth thickness adjusting process. In FIG. 31, a central portion of the hourglass worm 502 is seldom processed or processed only by a minute amount, and an amount of cut of the tooth profile is increased toward both end portions.

FIG. 30A shows the condition that the worm wheel 503 is turned CCW (counter-clockwise) by the input given by the direct action of the hourglass worm 502. In this condition, as shown in FIG. 30B, no meshing confliction is generated in the overall engagement between the hourglass worm 502 and the worm wheel 503.

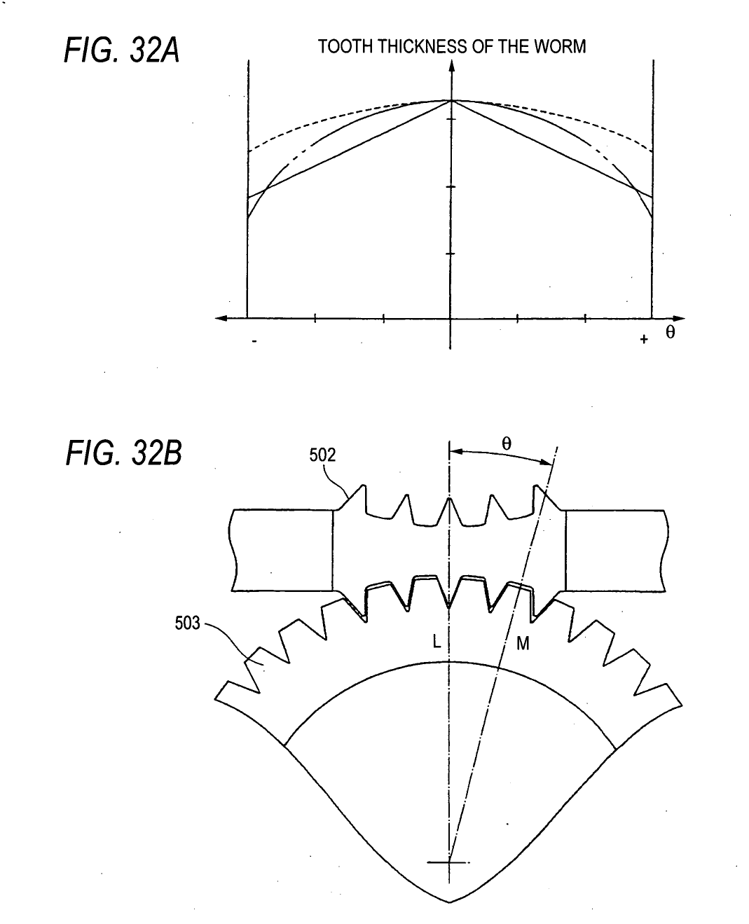

FIG. 32A is a graph showing a relationship between a tooth thickness of the worm and an angle from the center of the worm wheel, and FIG. 32B is a view explaining the graph in FIG. 32A.

As shown in FIG. 32B, if a straight line passing through a center of the worm wheel 503 and a center of the hourglass worm 502 in the axial direction is defined as L, each position of the hourglass worm 502 from the straight line L as the center in right and left directions in FIG. 32B is represented by an angle θ that is formed between another straight line M, which passes through this position and the center of the worm wheel 503, and the straight line L. In this case, the graph in FIG. 32A indicates that the tooth thickness of the hourglass worm 502 is reduced gradually as |θ| is increased, i.e., the position goes closer to both end portions. In FIG. 32A, a broken line indicates the type that the tooth thickness is reduced gradually as |θ| is increased, a chain double-dashed line indicates the type that an extent of reduction of the tooth thickness is increased as |θ| is increased, and a solid line indicates the type that the tooth thickness is reduced proportionally as |θ| is increased.

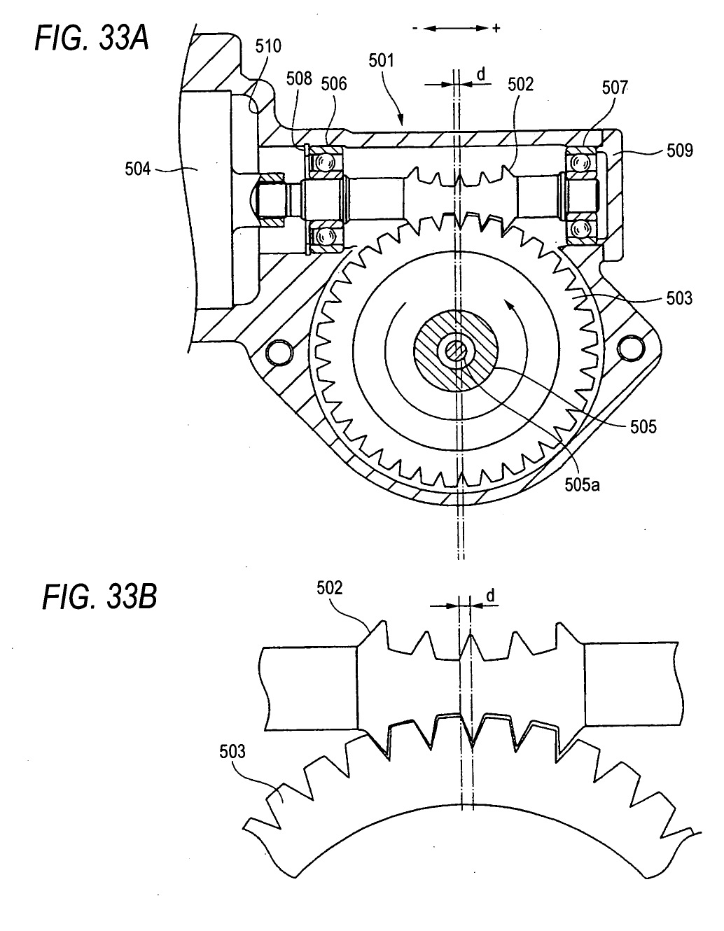

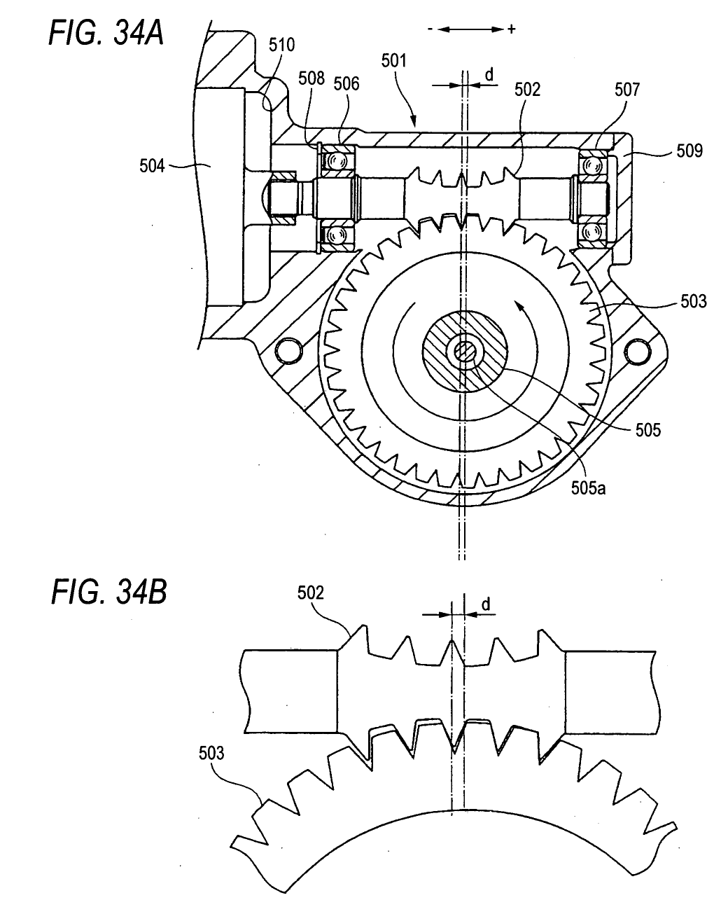

FIG. 33A is a longitudinal sectional view showing the reduction gear that contains an assembling error of the hourglass worm, to which the tooth thickness adjusting process is applied, in the axial direction (+ direction), and FIG. 33B is an enlarged view of an engaging portion. FIG. 34A is a longitudinal sectional view showing the reduction gear that contains the assembling error of the hourglass worm, to which the tooth thickness adjusting process is applied, in the axial direction (− direction), and FIG. 34B is an enlarged view of an engaging portion.

In the above configuration, as shown in FIG. 33A, even though the fitting error is generated to deviate the fitting position of the hourglass worm 502 by a distanced along the (+) direction of the axial direction, for example, when the assembling error is generated in the axial direction of the hourglass worm 502 upon assembling the reduction gear, the influence of the meshing confliction appears larger toward the (−) direction from the center of the worm 502 in the example in FIG. 42B, nevertheless the meshing confliction can be relaxed/suppressed in the engagement between the hourglass worm 502 and the worm wheel 503, as shown in FIG. 33B.

Similarly, as shown in FIG. 34A, even though the fitting error d is generated to deviate the fitting position of the hourglass worm 502 along the (−) direction of the axial direction, the influence of the meshing confliction appears larger toward the (+) direction from the center of the worm 502 in the example in FIG. 43B, nevertheless the meshing confliction can be relaxed in the engagement, as shown in FIG. 34B.

As a result, like the seventeenth embodiment, a defective operation, a reduction of the efficiency, etc. of the reduction gear due to the meshing confliction can be suppressed. Also, an influence of the assembling error in the axial direction is small in the center portion of the hourglass worm 502. Therefore, like the eighteenth embodiment, if the tooth thickness processing in the center portion of the hourglass worm 502 is lessened rather than both end portions, an increase of the backlash caused by the tooth thickness adjusting process can be suppressed.

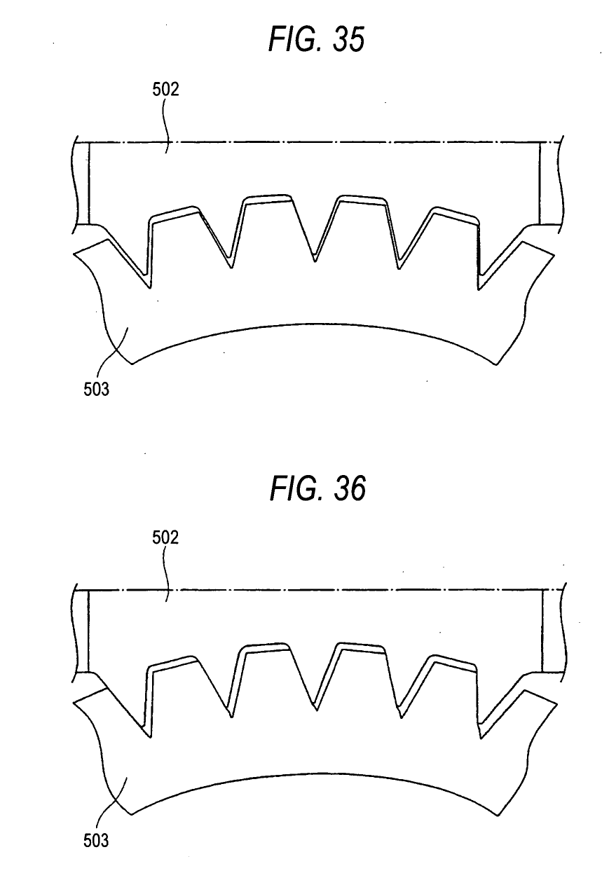

Also, FIG. 35 is an explanatory view showing an engagement between the hourglass worm, to which the tooth thickness adjusting process is applied, and the worm wheel at the time of the small torque transmission. FIG. 36 is an explanatory view showing the engagement between the hourglass worm, to which the tooth thickness adjusting process is applied, and the worm wheel at the time of the large torque transmission.

In the small torque transmission of the reduction gear, as shown in FIG. 35, the torque can be transmitted via a small extent of engagement such that only the teeth in the center portion of the hourglass worm 502 is meshed with the worm wheel 503. In the large torque transmission of the reduction gear, as shown in FIG. 36, since the worm wheel 503 is deflected, the torque can be transmitted via a large extent of engagement such that all teeth in the center portion of the hourglass worm 502 is meshed with the worm wheel 503. In this manner, since the torque can be transmitted via an extent of engagement that can respond to the torque, such an advantage can be expected that a transmission efficiency can be improved while maintaining the strength rather than the case where the torque is transmitted all the time via a large extent of engagement.

### Nineteenth Embodiment

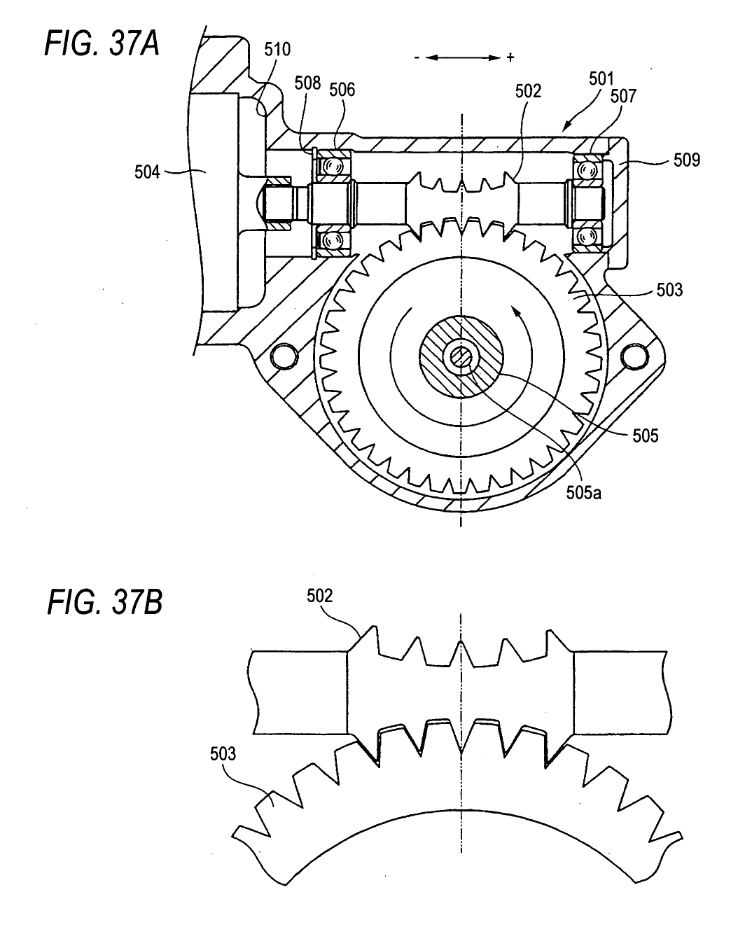

Next, a nineteenth embodiment of the present invention will be explained with reference to FIG. 37A to FIG. 41B hereunder.

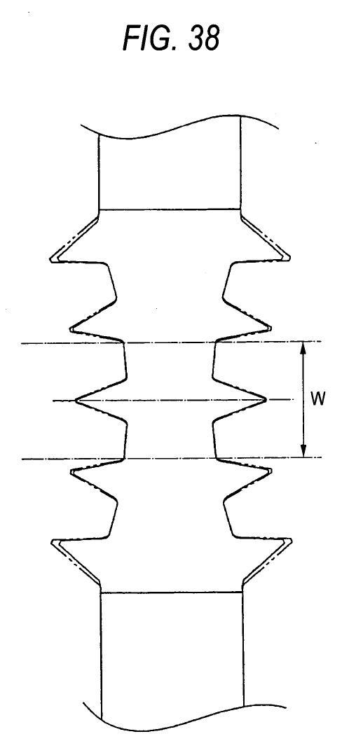

FIG. 37A is a longitudinal sectional view showing an hourglass worm reduction gear in an electric power steering according to a nineteenth embodiment of the present invention, and FIG. 37B is an enlarged view of an engaging portion. FIG. 38 is an enlarged view showing an hourglass worm in FIG. 37A.

The nineteenth embodiment is substantially similar to the above eighteenth embodiment, and the same reference numerals are affixed to the same members and parts as the above embodiment and thus their redundant explanation will be omitted herein. As shown in FIG. 37A and FIG. 38, it is similar to the eighteenth embodiment that the tooth thickness of the hourglass worm 502 is thinned gradually from the center to both end portions in the axial direction in the tooth thickness adjusting process, but a difference between them resides in that the tooth thickness adjusting process is not applied to a predetermined interval in the center portion of the hourglass worm 502. In the hourglass worm 502 shown in FIG. 38, the tooth thickness adjusting process is applied to shape the tooth profile from a shape indicated by a broken line to a shape indicated by a solid line. In FIG. 38, the process is not applied to an interval W in the center portion of the worm 502, but an amount of process is increased toward both end portions in remaining intervals to reduce the tooth thickness.

FIG. 37A shows the condition that the worm wheel 503 is turned CCW (counter-clockwise) by the input given by the direct action of the hourglass worm 502. In this condition, as shown in FIG. 37B, no meshing confliction is generated in the overall engagement between the hourglass worm 502 and the worm wheel 503.

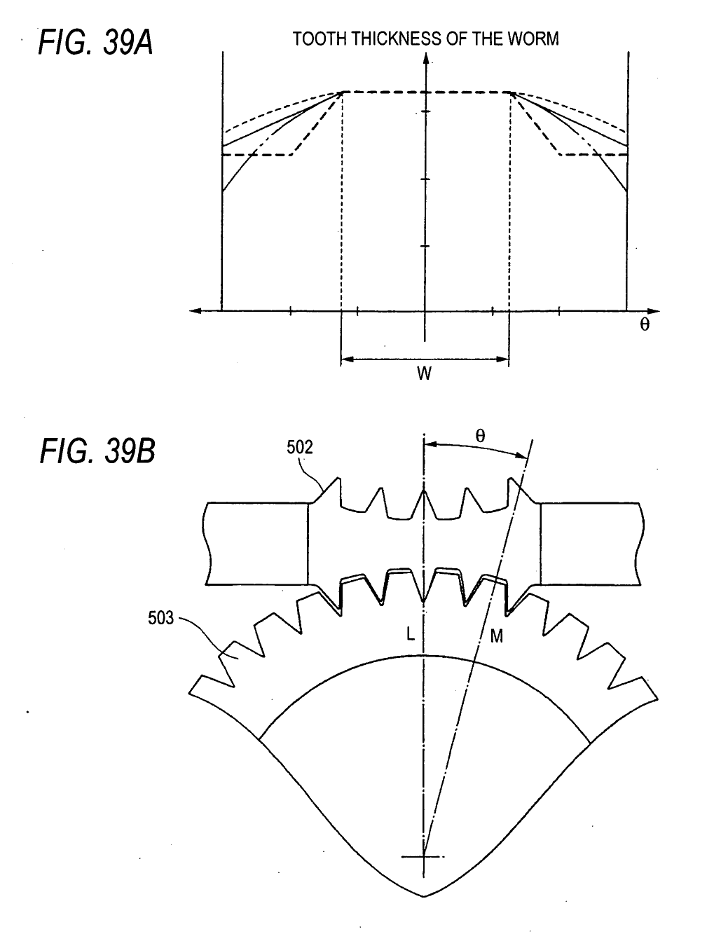

FIG. 39A is a graph showing a relationship between a tooth thickness of the worm and an angle from the center of the worm wheel, and FIG. 39B is a view explaining the graph in FIG. 39A.

As shown in FIG. 39B, a position on the hourglass worm 502 with respect to a straight line L, which passes through a center of the worm wheel 503 and a center of the worm 502, in right and left directions in FIG. 39B is represented by an angle θ that is formed between another straight line M, which passes through this position and the center of the worm wheel 503, and the straight line L. In this case, the graph in FIG. 39A indicates that the tooth thickness of the hourglass worm 502 is constant because the tooth thickness adjusting process is not applied at all to an interval W in the center portion, in which |θ| is within a predetermined range, and the tooth thickness is reduced gradually in a range in which |θ| is increased further. In FIG. 39A, a broken line indicates the type that the tooth thickness is reduced gradually as |θ| is increased beyond the interval W, a chain double-dashed line indicates the type that an extent of reduction of the tooth thickness is increased as |θ| is increased beyond the interval W, a solid line indicates the type that the tooth thickness is reduced proportionally as |θ| is increased beyond the interval W, and a thick broken line indicates the type that the tooth thickness is reduced linearly and then a predetermined tooth thickness is kept as |θ| is increased beyond the interval W.

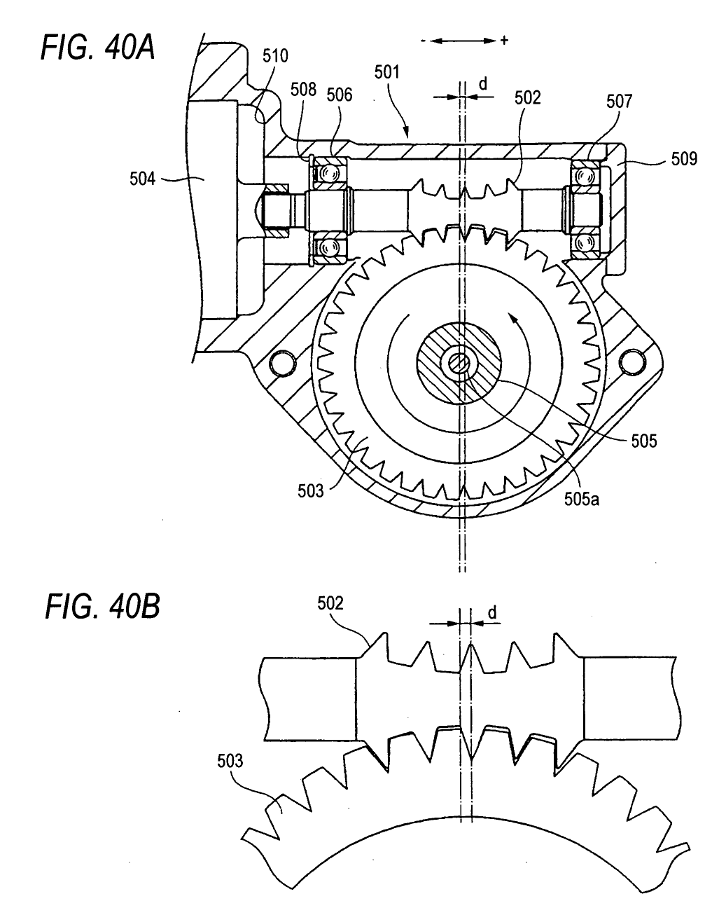

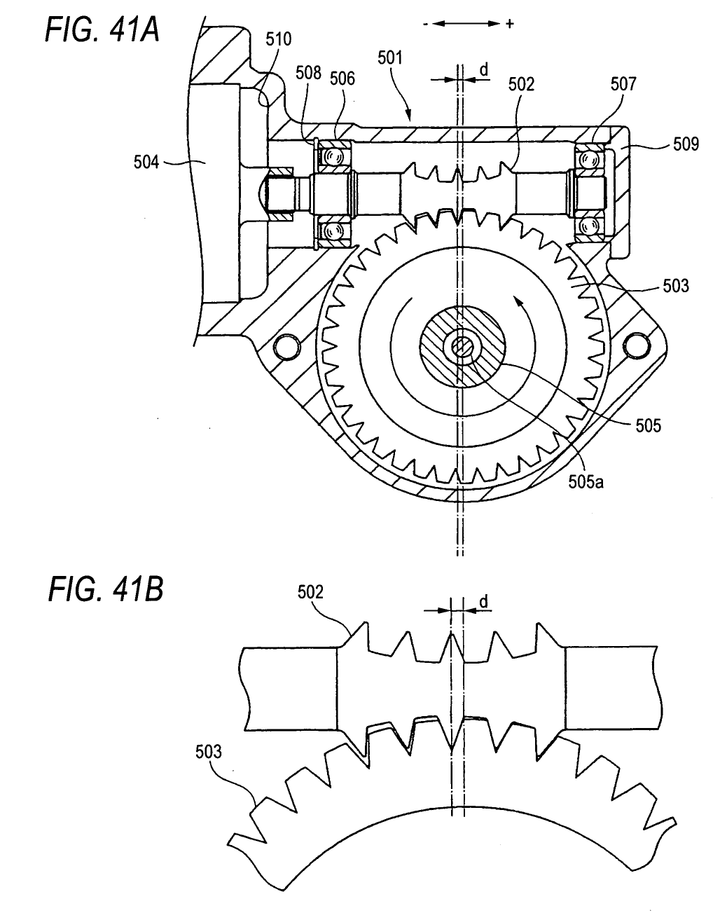

FIG. 40A is a longitudinal sectional view showing a reduction gear that contains an assembling error of the hourglass worm, to which the tooth thickness adjusting process is applied, in the axial direction (+ direction), and FIG. 40B is an enlarged view of an engaging portion. FIG. 41A is a longitudinal sectional view showing a reduction gear that contains the assembling error of the hourglass worm, to which the tooth thickness adjusting process is applied, in the axial direction (− direction), and FIG. 34B is an enlarged view of an engaging portion.

In the above configuration, as shown in FIG. 40A, even though the fitting error is generated to deviate the fitting position of the hourglass worm 502 by a distanced along the (+) direction of the axial direction, for example, when the assembling error is generated in the axial direction of the hourglass worm 502 upon assembling the reduction gear, the influence of the meshing confliction appears larger toward the (−) direction from the center of the worm 502 in the example in FIG. 43B, nevertheless such meshing confliction can be relaxed and suppressed in the engagement between the hourglass worm 502 and the worm wheel 503, as shown in FIG. 40B.

Similarly, as shown in FIG. 41A, even though the fitting error d is generated to deviate the fitting position of the hourglass worm 502 along the (−) direction of the axial direction, the influence of the meshing confliction appears larger toward the (+) direction from the center of the worm 502 in the example in FIG. 44B, nevertheless the meshing confliction can be relaxed in the engagement, as shown in FIG. 41B.

As a result, like the seventeenth embodiment, the defective operation, the reduction of the efficiency, etc. of the reduction gear due to the meshing confliction can be suppressed. Also, since the influence of the fitting error in the axial direction is small in the center portion of the worm 502, an increase of backlash caused by the tooth thickness adjusting process can be suppressed by providing the interval W, to which the tooth thickness adjusting process is not applied, in the center portion of the worm 502, like the nineteenth embodiment.

In the small torque transmission of the reduction gear, as shown in FIG. 35, the torque can be transmitted via a small extent of engagement in such a manner that only the teeth in the interval, in which the tooth thickness adjusting process is not applied, of the hourglass worm 502 is meshed with the worm wheel 503. In the large torque transmission of the reduction gear, as shown in FIG. 36, the torque can be transmitted via a large extent of engagement in such a manner that all teeth containing in the interval, in which the tooth thickness adjusting process is applied, of the hourglass worm 502 is meshed with the worm wheel 503 since the worm wheel 503 is deflected. In this manner, since the torque can be transmitted via an extent of engagement that can respond to the applied torque, such an advantage can also be expected that a transmission efficiency can be improved while maintaining the strength.

According to the seventeenth to nineteenth embodiments, generation of the meshing confliction in the engagement between the hourglass worm and the worm wheel can be suppressed by applying the tooth thickness adjusting process to the hourglass worm. Also, the defective operation, the reduction of efficiency, and the like of the worm gear system can be suppressed.

Also, since the tooth profile is shaped such that the tooth thickness is thinned toward both end portions from the center portion of the hourglass worm in the axial direction, the torque can be transmitted via a small extent of engagement in the small torque transmission of the reduction gear whereas the torque can be transmitted via a large extent of engagement in the large torque transmission because of the deflection of the worm wheel. As a result, the transmission efficiency can be improved while maintaining the strength.

In addition, the configurations in the fourteenth to nineteenth embodiments may be combined with the configurations in the first to thirteenth embodiments. Therefore, the fitting operation of the hourglass worm can be facilitated remarkably and thus the correction of the misalignment can be executed easily.

The present invention is explained in detail with reference to the particular embodiments as above. But it is apparent for the skilled person in the art that various variations and modifications may be applied without departing a spirit and a scope of the present invention.

This application was filed based on Japanese Patent Application (Patent Application No. 2003-181517) filed on Jun. 25, 2003, Japanese Patent Application (Patent Application No. 2003-181523) filed on Jun. 25, 2003, Japanese Patent Application (Patent Application No. 2003-181529) filed on Jun. 25, 2003, and Japanese Patent Application (Patent Application No. 2003-392623) filed on Nov. 21, 2003, and the contents thereof are incorporated herein by the reference.

### INDUSTRIAL APPLICABILITY

As described above, according to the present invention, the contact ratio can be improved by using the hourglass worm to attain the higher output, and also the correction of the misalignment can be performed easily by simplifying remarkably the fitting operation of the hourglass worm.

Also, according to the present invention, a lubricating performance can be improved by using the tooth profile with a special shape to improve considerably the abrasion durability.

In addition, according to the present invention, the contact ratio can be improved by using the hourglass worm to attain the higher output, and also the correction of the misalignment can be attained easily by simplifying remarkably the positioning operation of the hourglass worm.

1. The electric power steering according to claim 14, wherein
at least one of bearings that bear rotatably the hourglass worm is composed of a tapered roller bearing, an angular contact bearing, or a magneto ball bearing, from which an outer ring can be separated.

2. The electric power steering according to claim 14, wherein
a bearing holder is provided to at least one of bearings that bear rotatably the hourglass worm, and is put onto an outer ring of the bearing and has a taper surface on an outer peripheral surface, and
a taper hole with which the taper surface of the bearing holder is engaged is formed in a gear housing.

3. The electric power steering according to claim 14, wherein
a bearing holder is provided to at least one of bearings that bear rotatably the hourglass worm, and is fitted into an inner ring of the bearing and has a taper surface on an inner peripheral surface, and
a taper surface that is engaged with the taper surface of the bearing holder is formed on a shaft end portion of the hourglass worm.

4. The electric power steering according to claim 14, wherein
an inner peripheral surface of an inner ring of at least one of bearings that bear rotatably the hourglass worm is formed as a taper surface, and
a taper surface that is engaged with the taper surface of the inner ring is formed on the hourglass worm.

5. The electric power steering according to claim 14, wherein
at least one of bearings that bear rotatably the worm wheel is a tapered roller bearing, an angular contact bearing, or a magneto ball bearing, from which an outer ring can be separated.

6. The electric power steering according to claim 14, wherein
a bearing holder is provided to at least one of bearings that bear rotatably the worm wheel, and is put onto an outer ring and has a taper surface on an outer peripheral surface and
a taper hole with which the taper surface of the bearing holder is engaged is formed in a gear housing.

7. The electric power steering according to claim 14, wherein
at least one of bearings that bear rotatably the hourglass worm is provided such that a position can be changed with respect to a gear housing in a center-to-center direction.

8. An electric power steering for generating an assist steering torque from an electric motor in response to a steering torque applied to a steering wheel, and then transmitting the assist steering torque to an output shaft of a steering equipment after a speed reduction using a worm gear system,
wherein the worm gear system causes a worm driven by the electric motor to mesh with a worm wheel provided to the output shaft, and
a tooth profile of the worm wheel and a tooth profile of the worm are shaped into a special tooth profile in which a first line of contact and a second line of contact, which intersect with a sliding direction of the worm and intersect with each other, and a tooth surface of an intermediate gear is formed as a conical surface.

9. An electric power steering according to claim 8, wherein at least a dedendum shape of the worm is formed as a hourglass shape.

10. An electric power steering according to claim 8, wherein a consistency of a grease is set to 385 or less.

11. An electric power steering according to claim 10, wherein a width of the worm wheel is formed wider than a minimum dedendum circle diameter of the hourglass worm.

12. An electric power steering according to claim 10, wherein a clearance on both end sides is set larger than a clearance in a center portion of the worm wheel in a tooth trace direction.

13. An electric power steering according to claim 10, wherein the electric motor is a brushless motor.

14. An electric power steering for generating an assist steering torque from an electric motor in response to a steering torque applied to a steering wheel, and then transmitting the assist steering torque to an output shaft of a steering equipment after a speed reduction using a worm gear system,
wherein the worm gear system causes a hourglass worm driven by the electric motor to mesh with a worm wheel provided to the output shaft.

15. An electric power steering according to claim 14, wherein a backlash on both end portions of the hourglass worm is set larger than a backlash in an engagement center portion of the hourglass worm.

16. An electric power steering according to claim 14, wherein a number of working teeth between the hourglass worm and the worm wheel is increased in response to a transmission torque.

17. An electric power steering according to claim 16, wherein at least one of working teeth of the hourglass worm and the worm wheel can be deformed elastically.

18. An electric power steering according to claim 17, wherein at least tooth portion of the worm wheel is formed of resin material.

19. An electric power steering according to claim 18, wherein a number of threads of the hourglass worm is set to 2 threads or more.

20. An electric power steering according to claim 14, wherein a tooth thickness adjusting process of reducing each tooth thickness is applied to the hourglass worm.

21. An electric power steering according to claim 20, wherein the tooth thickness adjusting process of the tooth thickness adjusting process shapes a tooth profile such that a tooth thickness is thinned toward both end portions from a center portion of the worm in an axial direction.

22. An electric power steering according to claim 20, wherein the tooth thickness adjusting process of the tooth thickness adjusting process shapes the tooth profile such that the process is not applied to a predetermined interval of the center portion of the worm in the axial direction and the process is applied to remaining intervals either to reduce the tooth thickness toward both end portions or to form a constant tooth thickness that is thinner than the tooth thickness in an interval in which the process is not applied.
